(19) United States
(12) Patent Application Publication
(10) Pub. No.: US 2004/0076318 A1
(43) Pub. Date: Apr. 22, 2004

(54) Assaying and imaging system identifying traits of biological specimens

(75) Inventors: Edward Faeldt, Backefors (SE); Luis Serrano, Heidelberg (DE); Cayetano Gonzalez, Madrid (DE); Christian Boulin, Wiesloch (DE); Christopher J. Cummings, Brookline, MA (US); Juan Botas, Houston, TX (US); Huda Zoghbi, Houston, TX (US)

Correspondence Address: PALMER & DODGE, LLP, KATHLEEN M. WILLIAMS, 111 HUNTINGTON AVENUE, BOSTON, MA, 02199, US

(73) Assignees: Baylor College of Medicine; European Molecular Biology Laboratory (EMBL); EnVivo Pharmaceuticals

(21) Appl. No.: 10/618,869

(22) Filed: Jul. 14, 2003

Related U.S. Application Data
(60) Provisional application No. 60/396,064, filed on Jul. 15, 2002.
(60) Provisional application No. 60/396,339, filed on Jul. 15, 2002.

(51) Int. Cl. G06K 9/00

(52) U.S. Cl. 382/128

(57) ABSTRACT

A method of system is provided for assaying specimens. In connection with such system or method, plural multi-pixel target images of a field of view are obtained at different corresponding points in time over a given sample period. A background image is obtained using a plural set of the plural target images. For a range of points in time, the background image is removed from the target images to produce corresponding background-removed target images. Analysis is performed using at least a portion of the corresponding background-removed target images to identify visible features of the specimens. A holding structure is provided to hold a set of discrete specimen containers. A positioning mechanism is provided to position a plural subset of the containers to place the moving specimens within the plural subset of the containers within a field of view of the camera.

### RELATED APPLICATION DATA

This application claims priority to U.S. Provisional Application Nos. 60/396,064 filed on Jul. 15, 2002, and 60/396,339 filed on Jul. 15, 2002. The content of each of these applications is hereby expressly incorporated by reference herein in its entirety.

### COPYRIGHT NOTICE

This patent document contains information subject to copyright protection. The copyright owner has no objection to the facsimile reproduction by anyone of the patent document or the patent, as it appears in the U.S. Patent & Trademark Office files or records but otherwise reserves all copyright rights whatsoever.

### BACKGROUND

1. Field of the Invention

Aspects of the present invention relate to certain assaying systems and tools for identifying traits of biological specimens. Other aspects of the invention relate to using imaging to identify behavioral traits of animal specimens.

2. Description of Background Information

Imaging systems have been developed to record over time information regarding the movement of biological specimens. Such information can then be stored, retrieved, and analyzed generally to help an overall biological research process or more specifically to facilitate drug discovery screening.

### SUMMARY

The present invention in certain aspects is directed to systems, subsystems, methods, and/or machine-readable mechanisms (e.g., computer-readable media) to facilitate the high-throughput acquisition and recording of trait data concerning sets of biological specimens. In other aspects, the invention is directed to an assay machine, provided with mechanisms to act on (e.g., treat, excite) numerous containers of specimens and to capture images (or otherwise sensed information) regarding activity, behavior, and other biological changes manifested in biological specimens. Such sensible activity may include a change in the cellular structure of an animal, or a change in behavior of an animal—e.g., as represented by detected movements or locations within space at given points in time.

Image processing techniques can be used to automatically identify certain behaviors in a group of specimens, by processing background-removed target images of the specimens at given points in time. Since there are a large number of specimens moving at random, it is difficult to estimate the background information in a target image, to thereby be able to remove the background image and produce a background-removed target image. In an aspect of the invention, tools are provided to facilitate the estimation of background information in the target images, so the estimated background information can be removed from the target images.

In an exemplary embodiment, a system is provided for assaying plural biological specimens. Each of the specimens moves within a field of view. Plural multi-pixel target images of the field of view are obtained at different corresponding points in time. A background image is obtained using a plural set of the plural target images. For a range of the points in time, the background image is removed to produce corresponding background-removed target images. Analysis is performed using at least a portion of the corresponding background-removed target images to identify visible features of the specimens.

In an exemplary embodiment, frames of a digitized movie can be processed by superimposing the frames to obtain a background approximation. A characteristic pixel value for pixels of the background approximation can be determined based on pixels of the superimposed frames.

In another exemplary embodiment, frames of the digitized movie can be processed by identifying a first image (first image block) in a first frame of the movie, and a first trajectory can be assigned to the first block. A second image block can be identified in the first frame, and a second trajectory can be assigned to the second image block. A third image block can be identified in a second frame of the movie, and the first and second trajectories can be assigned to the third image block if the third image block is within a specified distance of the first and second trajectories. If the third image block is assigned to the first and second trajectories, one or more characteristics of the first image block in association with the first trajectory and one or more characteristics of the second image block in associate with the second trajectory are stored.

In another exemplary embodiment, frames of the movie can be processed by identifying a first image block in a frame of the movie. A velocity vector and an orientation can be defined for the first image block, and an amount of stumbling can be determined based on an angle between the velocity vector and the orientation.

### BRIEF DESCRIPTION OF THE DRAWINGS

FIG. 1 is a side view of an exemplary motion tracking system;

FIG. 2 is an exemplary process for processing and analyzing a digitized movie;

FIG. 3 is an exemplary process for processing frames of a digitized movie;

FIG. 4 depicts an exemplary frame of a digitized movie;

FIG. 5 depicts an exemplary background approximation of an exemplary frame of a digitized movie;

FIG. 6 depicts an exemplary binary image of an exemplary frame of a digitized movie;

FIG. 7 depicts a normalized sum of an exemplary binary image of an exemplary frame of a digitized movie;

FIG. 8 depicts an exemplary image block;

FIG. 9 is an exemplary process for tracking motion of specimens captured by a digitized movie;

FIG. 10 depicts an exemplary trajectory;

FIGS. 11A and 11B depict assigning an exemplary trajectory to an exemplary image block;

FIG. 12 depicts assigning two exemplary trajectories to an exemplary image block;

FIGS. 13A to 13E depict exemplary frames of a digitized movie;

FIGS. 14A to 14E depict exemplary binary images of the exemplary frames depicted in FIGS. 13A to 13E;

FIGS. 15A to 15D depict exemplary binary images;

FIG. 16 depicts exemplary trajectories;

FIG. 17 depicts an exemplary amount of turning;

FIGS. 18A and 18B depict an exemplary amount of stumbling;

FIG. 19 is a block diagram of a second embodiment of an assaying system;

FIG. 20 is a simplified perspective view of an imaging station;

FIG. 21 is a simplified side view of a staged imaging station approach;

FIG. 22 is a flowchart of a test and reference animal population comparison process;

FIG. 23 is a bar graph from Example 1 showing the results of an assay of treated and control flies;

FIG. 24 is a line graph from Example 2 showing motor performance, assessed by the Cross150 score (y-axis) plotted against time (x-axis);

FIGS. 25A-25J from Example 3 are ten plots showing the average p-values for different populations for each combination of a certain number of video repeats and replica vials; and

FIG. 26 from Example 3 is a line graph showing motor performance on the y-axis (Cross150) plotted against time on the x-axis (Trials).

### DETAILED DESCRIPTION

The following description sets forth numerous specific configurations, parameters, and other features. It should be recognized, however, that such description is not intended as a limitation on the scope of the present invention, but is instead provided as a description of exemplary embodiments.

### I. Robotics

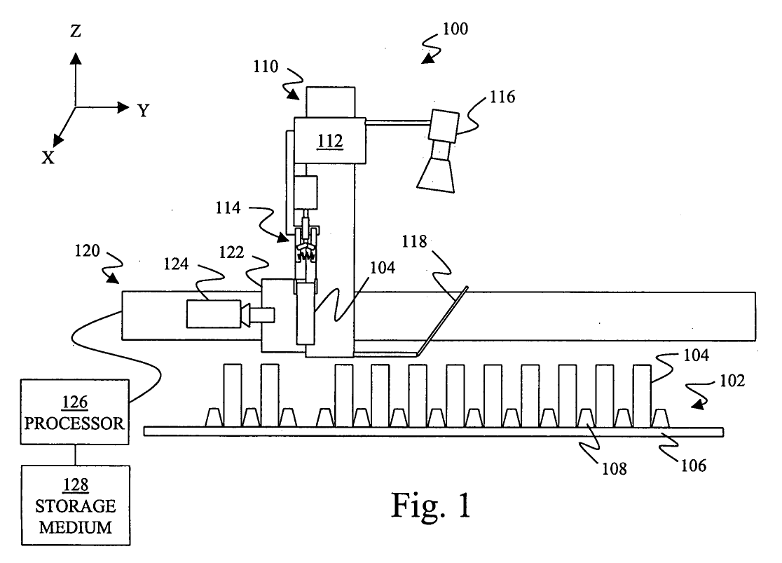

In FIG. 1, an exemplary motion tracking system 100 is depicted. As described below in greater detail, motion-tracking system 100 can operate to monitor the activity of specimens in specimen containers 104. For the sake of example, motion tracking system 100 is described below in connection with monitoring the activity of flies within optically transparent tubes. It should be noted, however, that motion-tracking system 100 can be used in connection with monitoring the activities of various biological specimens within various types of containers. As used herein, a “biological specimen” refers to an organism of the kingdom Animalia. A “biological specimen”, as used herein may refer to a wild-type specimen, or alternatively, a specimen which comprises one or more mutations, either naturally occurring, or artificially introduced (e.g., a transgenic specimen, or knock-in specimen). A “biological specimen”, as used herein preferably refers to an animal, preferably a non-human animal, preferably a non-human mammal, and can be selected from vertebrates, invertebrates, flies, fish, insects, and nematodes. In one embodiment, a biological specimen is an animal which is no larger in size than a rodent such as a mouse or a rat. Alternatively, a “biological specimen” as used herein refers to an organism which is not a rodent, and more preferably which is not a mouse. In a particularly preferred embodiment, a “biological specimen” as used herein refers to a fly. As used herein, “fly” refers to an insect with wings, such as, but not limited to Drosophila. As used herein, the term “Drosophila” refers to any member of the Drosophilidae family, which include without limitation, Drosophila funebris, Drosophila multispina, Drosophila subfunebris, guttifera species group, Drosophila guttifera, Drosophila albomicans, Drosophila annulipes, Drosophila curviceps, Drosophila formosana, Drosophila hypocausta, Drosophila immigrans, Drosophila keplauana, Drosophila kohkoa, Drosophila nasuta, Drosophila neohypocausta, Drosophila niveifrons, Drosophila pallidiftons, Drosophila pulaua, Drosophila quadrilineata, Drosophila siamana, Drosophila sulfurigaster albostrigata, Drosophila sulfurigaster bilimbata, Drosophila sulfurigaster neonasuta, Drosophila Taxon F, Drosophila Taxon I, Drosophila ustulata, Drosophila melanica, Drosophila paramelanica, Drosophila tsigana, Drosophila daruma, Drosophila polychaeta, quinaria species group, Drosophila falleni, Drosophila nigromaculata, Drosophila palustris, Drosophila phalerata, Drosophila subpalustris, Drosophila eohydei, Drosophila hydei, Drosophila lacertosa, Drosophila robusta, Drosophila sordidula, Drosophila repletoides, Drosophila kanekoi, Drosophila virilis, Drosophila maculinatata, Drosophila ponera, Drosophila ananassae, Drosophila atripex, Drosophila bipectinata, Drosophila ercepeae, Drosophila malerkotliana malerkotliana, Drosophila malerkotliana pallens, Drosophila parabipectinata, Drosophila pseudoananassae pseudoananassae, Drosophila pseudoananassae nigrens, Drosophila varians, Drosophila elegans, Drosophila gunungcola, Drosophila eugracilis, Drosophila ficusphila, Drosophila erecta, Drosophila mauritiana, Drosophila melanogaster, Drosophila orena, Drosophila sechellia, Drosophila simulans, Drosophila teissieri, Drosophila yakuba, Drosophila auraria, Drosophila baimaii, Drosophila barbarae, Drosophila biauraria, Drosophila birchii, Drosophila bocki, Drosophila bocqueti, Drosophila burlai, Drosophila constricta (sensu Chen & Okada), Drosophila jambulina, Drosophila khaoyana, Drosophila kikkawai, Drosophila lacteicornis, Drosophila leontia, Drosophila lini, Drosophila mayri, Drosophila parvula, Drosophila pectinifera, Drosophila punjabiensis, Drosophila quadraria, Drosophila rufa, Drosophila seguyi, Drosophila serrata, Drosophila subauraria, Drosophila tani, Drosophila trapezifrons, Drosophila triauraria, Drosophila truncata, Drosophila vulcana, Drosophila watanabei, Drosophila fuyamai, Drosophila biarmipes, Drosophila mimetica, Drosophila pulchrella, Drosophila suzukii, Drosophila unipectinata, Drosophila lutescens, Drosophila paralutea, Drosophila prostipennis, Drosophila takahashii, Drosophila trilutea, Drosophila bifasciata, Drosophila imaii, Drosophila pseudoobscura, Drosophila saltans, Drosophila sturtevanti, Drosophila nebulosa, Drosophila paulistorum, and Drosophila willistoni. In one embodiment, the fly is Drosophila melanogaster.

In one exemplary embodiment of motion tracking system 100, a robot 114 removes a specimen container 104 from a specimen platform 102, which holds a plurality of specimen containers 104. Robot 114 positions specimen container 104 in front of camera 124. Specimen container 104 is illuminated by a lamp 116 and a light screen 118. Camera 124 then captures a movie of the activity of the biological specimens within specimen container 104. After the movie has been obtained, robot 114 places specimen container 104 back onto specimen platform 102. Robot 114 can then remove another specimen container 104 from specimen platform 102. A processor 126 can be configured to coordinate and operate specimen platform 102, robot 104, and camera 124. As described below, motion tracking system 100 can be configured to receive, store, process, and analyze the movies captured by camera 124.

In the present embodiment, specimen platform 102 includes a base plate 106 into which a plurality of support posts 108 is implanted. In one exemplary configuration, specimen platform 102 includes a total of 416 support posts 108 configured to form a 25×15 array to hold a total of 375 specimen containers 104. As depicted in FIG. 1A, support posts 108 can be tapered to facilitate the placement and removal of specimen containers 104. It should be noted that specimen platform 102 can be configured to hold any number of specimen containers 104 in any number of configurations.

Motion tracking system 100 also includes a support beam 110 having a base plate 112 that can translate along support beam 110, and a support beam 120 having a base plate 122 that can translate along support beam 120. In FIG. 1A, support beam 110 and support beam 120 are depicted extending along the Y axis and Z axis, respectively. As such, base plate 112 and base plate 122 can translate along the Z axis and Y axis, respectively. It should be noted, however, that the labeling of the X, Y, and Z axes in FIG. 1A is arbitrary and provided for the sake of convenience and clarity.

In the present embodiment, robot 114 and lamp 116 are attached to base plate 112, and camera 124 is attached to base plate 122. As such, robot 114 and lamp 116 can be translated along the Z axis, and camera 124 can be translated along the Y axis. Additionally, support beam 110 is attached to base plate 122, and can thus translate along the Y axis. Support beam 120 can also be configured to translate along the X axis. For example, support beam 120 can translate on two linear tracks, one on each end of support beam 120, along the X axis. As such, robot 114 can be moved in the X, Y, and Z directions. Additionally, robot 114 and camera 124 can be moved to various X and Y positions over specimen platform 102. Alternatively, specimen platform 102 can be configured to translate in the X and/or Y directions.

Motion tracking system 100 can be placed within a suitable environment to reduce the effect of external light conditions. For example, motion tracking system 100 can be placed within a dark container. Additionally, motion tracking system 100 can be placed within a temperature and/or humidity controlled environment.

### II. Capturing and Processing Images of Specimens

As noted above, motion-tracking system 100 can be used to monitor the activity of specimens within specimen container 104. As also noted above, in one exemplary application, the movement of flies within specimen container 104 can be captured in a movie taken by camera 124, then analyzed by processor 126. As used herein, the term “movie” has its normal meaning in the art and refers a series of images (e.g., digital images) called “frames” captured over a period of time. A movie has two or more frames and usually comprises at least 10 frames, often at least about 20 frames, often at least about 40 frames, and often more than 40 frames. The frames of a movie can be captured over any of a variety of lengths of time such as, for example, at least one second, at least about two, at least about 3, at least about 4, at least about 5, at least about 10, or at least about 15 seconds. The rate of frame capture can also vary. Exemplary frame rates include at least 1 frame per second, at least 5 frames per second or at least 10 frames per second. Faster and slower rates are also contemplated.

In the present exemplary application, to capture a movie of the movement of flies within specimen container 104, robot 114 grabs a specimen container 104 and positions it in front of camera 124. However, before positioning specimen container 104 in front of camera 124, robot 114 first raises specimen container 104 above a distance, such as about 2 centimeters, above base plate 106, then releases specimen container 104, which forces the flies within specimen container 104 to fall down to the bottom of specimen container 104. Robot 114 then grabs specimen container 104 again and positions it to be filmed by camera 124. In one exemplary embodiment, camera 124 captures about 40 consecutive frames at a frame rate of about 10 frames per second. It should be noted, however, that the number of frames captured and the frame rate used can vary. Additionally, the step of dropping specimen container 104 prior to filming can be omitted.

As described above, motion tracking system 100 can be configured to receive, store, process, and analyze the movie captured by camera 124. In one exemplary embodiment, processor 126 includes a computer with a frame grabber card configured to digitize the movie captured by camera 124. Alternatively, a digital camera can be used to directly obtain digital images. Motion tracking system 100 can also includes a storage medium 128, such as a hard drive, compact disk, digital video disc, and the like, to store the digitized movie. It should be noted, however, that motion tracking system 100 can include various hardware and/or software to receive and store the movie captured by camera 124. Additionally, processor 126 and/or storage medium 128 can be configured as a single unit or multiple units.

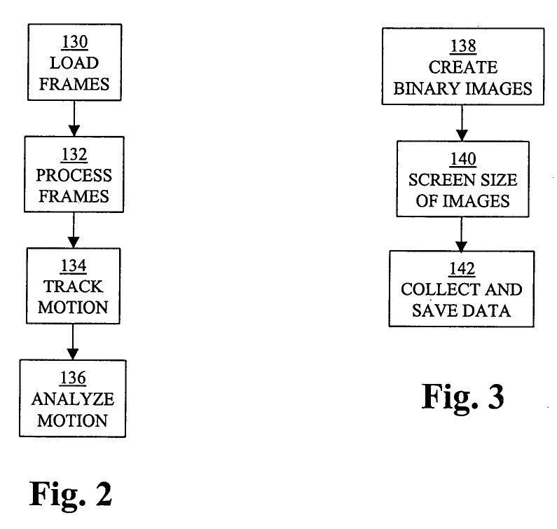

With reference to FIG. 2, an exemplary process of processing and analyzing the movie captured by camera 124 (FIG. 1) is depicted. In one exemplary embodiment, the exemplary process depicted in FIG. 2 can be implemented in a computer program.

In step 130, the frames of the movie are loaded into memory. For example, processor 126 can be configured to obtain one or more frames of the movie from storage medium 128 and load the frames into memory. In step 132, the frames are processed, in part, to identify the specimens within the movie. In step 134, the movements of the specimens in the movie are tracked. In step 136, the movements of the specimens are then analyzed. It should be noted that one or more of these steps can be omitted and that one or more additional steps can also be added. For example, the movements of the specimens in the movie can be tracked (i.e., step 134) without having to analyze the movements (i.e., step 136). As such, in some applications, step 136 can be omitted.

With reference to FIG. 3, an exemplary process of processing the frames of the movie (i.e., step 132 in FIG. 2) is depicted. In one exemplary embodiment, the exemplary process depicted in FIG. 3 can be implemented in a computer program.

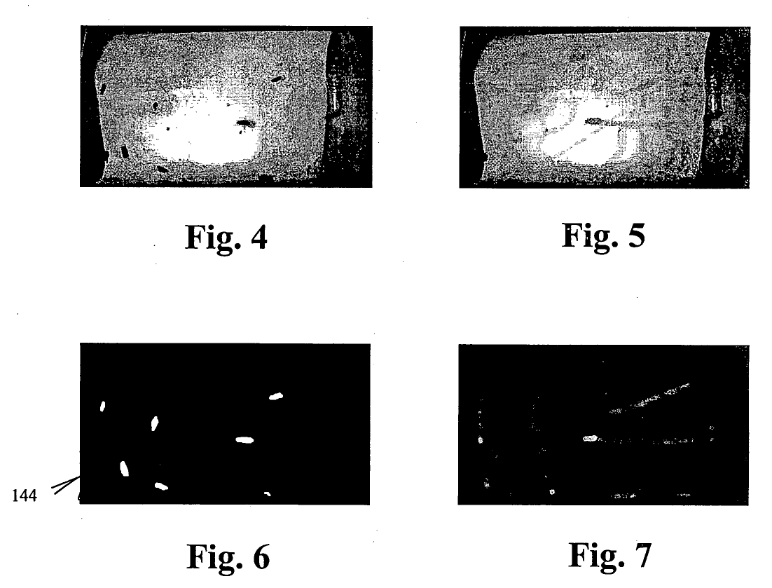

FIG. 4 depicts an exemplary frame of biological specimens within a specimen container 104 (FIG. 1), which in this example are flies within a transparent tube. As depicted in FIG. 4, the frame includes images of flies in specimen container 104 (FIG. 1) as well as unwanted images, such as dirt, blemishes, occlusions, and the like. As such, with reference to FIG. 3, in step 138, a binary image is created for each frame of the movie to better identify the images that may correspond to flies in the frames.

In one exemplary embodiment, a background approximation for the movie can be obtained by superimposing two or more frames of the movie, then determining a characteristic pixel value for the pixels in the frames. The characteristic pixel value can include an average pixel value, a median pixel value, and the like. Additionally, the background approximation can be obtained based on a subset of frames or all of the frames of the movie. The background approximation normalizes non-moving elements in the frames of the movie. FIG. 5 depicts an exemplary background approximation. In the exemplary background approximation, note that the unwanted images in FIG. 4 have been removed, and the streaks can indicate the movement of flies.

To generate a binary image, the background approximation is subtracted from a frame of the movie. By subtracting the background approximation from a frame, the binary image of the frame captures the moving elements of the frame. Additionally, a gray-scale threshold can be applied to the frames of the movie. For example, if a pixel in a frame is darker than the threshold, it is represented as being white in the binary image. If a pixel in the frame is lighter than the threshold, it is represented as being black in the binary image. More particularly, if the difference between an image pixel value and the background pixel value is less than the difference between a threshold value and the value of a white pixel (i.e., [Image Pixel Value]−[Background Pixel Value]<[Threshold Value]−[Pixel Value of White Pixel]), then the binary image pixel is set as white. For example, if the pixel value of a black pixel is assumed to be 0 and a white pixel is assumed to be 255, an exemplary threshold value of 230 can be used.

With reference again to FIG. 3, in step 140, the image blocks in the frames of the movie are screened by pixel size. More particularly, image blocks in a frame having an area greater than a maximum threshold or less than a minimum threshold are removed from the binary image. For example, FIG. 6 depicts an exemplary binary image, which was obtained by subtracting the background approximation depicted in FIG. 5 from the exemplary frame depicted in FIG. 4 and removing image blocks in the frames having areas greater than 1600 pixels or less than 30 pixels. The image blocks are also screened for eccentricity. As used herein, “eccentricity” refers to the relationship between width and length of an image block. For example, where a biological specimen of the invention is a fly, the accepted eccentricity values range between 1 and 5 (that is, the ratio of width to length is within a range of 1 to 5). The eccentricity value of a given biological specimen can be determined empirically by one of skill in the art based on the average width and length measurements of the specimen. Once the eccentricity value of a given biological specimen is determined, that value will be permitted to increase by a doubling of the value or decrease by half the value, and still be considered to be within the acceptable range of eccentricity values for the particular biological specimen. Image blocks which fall outside the accepted eccentricity value for a given biological specimen (or sample of plural biological specimens) will be excluded from the analysis (i.e., blocks that are too long and/or narrow to be a fly are excluded).

As depicted in FIG. 6, the image blocks 144 that may correspond to specimens, and more specifically flies in this present exemplary application, can be more easily identified in the binary image. FIG. 7 depicts a normalized sum of the binary images of the frames of the movie, which can provide an indication of the movements of the flies during the movie. In FIGS. 6 and 7, image blocks 144 are depicted as being white, and the background depicted as being black. It should be noted, however, that image blocks 144 can be black, and the background white.

With reference to FIG. 3, in step 142, data on image blocks 144 (FIG. 6) are collected and stored. In one exemplary embodiment, the collected and stored data can include one or more characteristics of image blocks 144 (FIG. 6), such as length, width, location of the center, area, and orientation.

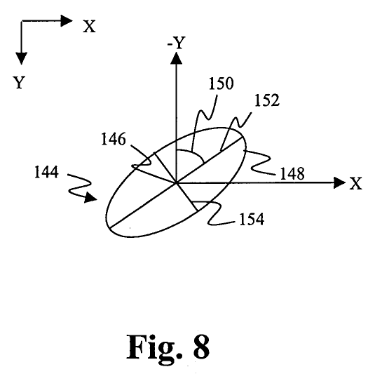

With reference to FIG. 8, a long axis 152 and a short axis 154 for image block 144 can be determined based on the shape and geometry of image block 144. The length of long axis 152 and the length of short axis 154 are stored as the length and width, respectively, of image block 144.

A center 146 can be determined based on the center of gravity of the pixels for image block 144. The center of gravity can be determined using the image moment for an image block 144, according to methods which are well established in the art. The location of center 146 can then be determined based on a coordinate system for the frame. With reference to FIG. 1, in the present example, camera 124 is tilted such that the frames captured by camera 124 are rotated 90 degrees. As such, as indicated by the coordinate system used in FIG. 8, in the frames captured by camera 124, the top and bottom of specimen container 104 is located on the left and right sides, respectively, of the frame. Furthermore, as indicated by the coordinate system used in FIG. 8, for the purpose of tracking the movement of image blocks 144, the X-axis corresponds to the length of specimen container 104 (FIG. 1), where the zero X position corresponds to a location near the top of specimen container 104 (FIG. 1). The Y-axis corresponds to the width of specimen container 104 (FIG. 1), where the zero Y position corresponds to a location near the right edge of specimen container 104 (FIG. 1) as depicted in FIG. 1. Thus, when a fly moves from the bottom of specimen container 104 (FIG. 1) toward the top, it moves in a negative X direction. When the fly moves from left to right in the specimen container 104 (FIG. 1), it moves in a negative Y direction. In one exemplary embodiment, the zero X and Y position is the upper left corner of a frame. It should be noted that the labeling of the X and Y axes is arbitrary and provided for the sake of convenience and clarity.

With reference to FIG. 8, an area 148 can be determined based on the shape and geometry of image block 144. For example, area 148 can be defined as the number of pixels that fall within the bounds of image block 144. It should be noted that area 148 can be determined in various manners and defined in various units.

An orientation 150 can be determined based on long axis 152 for image block 144. For example, as depicted in FIG. 8, orientation 150 can be defined as an angle long axis 152 of image block 144 and an axis of the coordinate system of the frame, such as the Y axis as depicted in FIG. 8. It should be noted that orientation 150 can be determined and defined in various manners.

In one exemplary embodiment, data for image blocks 144 in each frame of the movie are first collected and stored. As described below, trajectories of the image blocks 144 are then determined for the entire movie. Alternatively, data for image blocks 144 and the trajectories of the image blocks 144 can be determined frame-by-frame.

### III. Trajectory

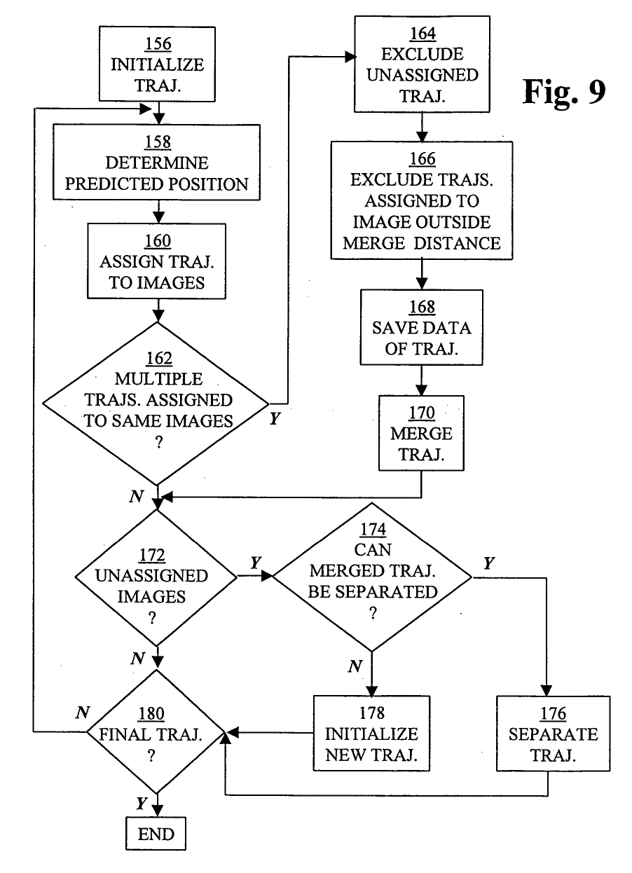

With reference again to FIG. 2, in the present embodiment, in step 134, the movements of the specimens in the movie are tracked. More particularly, FIG. 9 depicts an exemplary process for tracking the movements of the specimens in the movie. In one exemplary embodiment, the exemplary process depicted in FIG. 9 can be implemented in a computer program.

In step 156, for the first frame of the movie, trajectories of image blocks 144 (FIG. 6) are initialized. More specifically, a trajectory is initialized for each image block 144 identified in the first frame. The trajectory includes various data, such as the location of the center, area, and orientation of image block 144. The trajectory also includes a velocity vector, which is initially set to zero.

In step 158, a predicted position is determined. For example, the predicted position of an image block 144 (FIG. 6) and/or trajectory can be determined based on its previous position and velocity vector. More specifically, in one configuration, the predicted position can be determined as: [Predicted Position]=[Previous Position]+[Prediction Factor]×[Previous Velocity Vector], where the prediction factor can vary between zero and one.

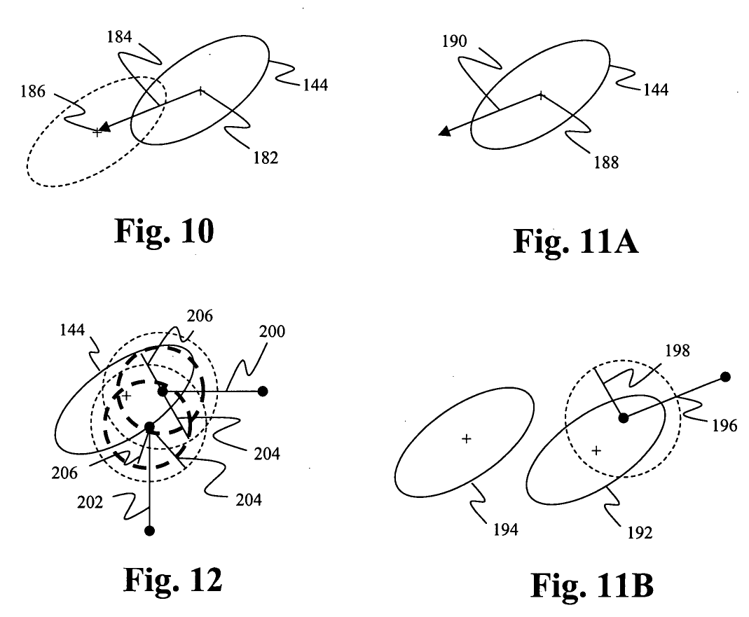

For example, with reference to FIG. 10, assume that in one frame a trajectory having a center position 182 and a velocity vector 184 has been initialized based on image block 144. If the prediction factor is zero, the predicted position in the next frame would be the previous center position 182. If the prediction factor is one, the prediction position in the next frame would be position 186. In one exemplary embodiment, a prediction factor of zero is used, such that the predicted position is the same as the previous position. However, the prediction factor used can be adjusted and varied depending on the particular application.

Additionally, a predicted velocity can be determined based on the previous velocity vector. For example, the predicted velocity can be determined to be the same as the previous velocity.

With reference to FIG. 9, in step 160, the next frame of the movie is loaded and the trajectories are assigned to image blocks 144 (FIG. 6) in the new frame. More specifically, each trajectory of a previous frame is compared to each image block 144 (FIG. 6) in the new frame. If only one image block 144 (FIG. 6) is within a search distance of a trajectory, and more specifically within the predicted position of the trajectory, then that image block 144 (FIG. 6) is assigned to that trajectory. If none of the image blocks 144 (FIG. 6) are within the search distance of a trajectory, that trajectory is unassigned and will be hereafter referred to as an “unassigned trajectory.” However, if more than one image block 144 (FIG. 6) falls within the search distance of a trajectory, and more specifically within the predicted position of the trajectory, the image block 144 (FIG. 6) closest to the predicted position of that trajectory is assigned to the trajectory.

For example, in one exemplary embodiment, if more than one image block 144 (FIG. 6) falls within the search distance of a trajectory, a distance between each of the image blocks 144 (FIG. 6) and the trajectory can be determined based on the position of the image block 144 (FIG. 6), the prediction position of the trajectory, a speed factor, the velocity of the image block 144 (FIG. 6), and the predicted velocity of the trajectory. More particularly, the distance between each image block 144 (FIG. 6) and the trajectory can be determined as the value of: norm([Position of the image block]−[Predicted position of the image block]+[Speed factor]* norm ([Velocity]−[Predicted Velocity])). A norm function is the length of a two-dimensional vector, meaning that only the magnitude of a vector is used. The speed factor can be varied from zero to one, where zero corresponds to ignoring the velocity of the image block and one corresponds to giving equal weight to the velocity and the position of the image block. In the present exemplary embodiment, the image block 144 (FIG. 6) having the shortest distance is assigned to the trajectory. Additionally, a speed factor of 0.5 is used.

With reference to FIG. 11A, assume that in one frame a trajectory having a center position 188 and a velocity vector 190 has been initialized based on image block 144. With reference to FIG. 11B, in the next frame, the trajectory, which is now depicted as trajectory 196, is assigned to an image block 144. Assuming that a prediction factor of zero is used, a search distance 198 associated with trajectory 196 is centered about the previous center position 188 (FIG. 11A). Thus, in the example depicted in FIG. 11B, image block 192 is assigned to trajectory 196, while image block 194 is not. In one exemplary embodiment, a search distance of [350 pixels per second]/[frame rate] is used, where the frame rate is the frame rate of the movie. For example, if the frame rate is 5 frames per second, then the search distance is 70 pixels/frame. It should be noted that various search distances can be used depending on the application.

With reference to FIG. 9, in step 162, the trajectories of the current frame are examined to determine if multiple trajectories have been assigned to the same image block 144 (FIG. 6). For example, with reference to FIG. 12, assume that image block 144 lies within search distance 204 of trajectories 200 and 202. As such, image block 144 is assigned to trajectories 200 and 202.

With reference to FIG. 9, in step 164, unassigned trajectories are excluded from being merged. More particularly, multiple trajectories assigned to an image block 144 (FIG. 6) are examined to determined if any of the trajectories were unassigned trajectories in the previous frame. The unassigned trajectories are then excluded from being merged.

In step 166, trajectories assigned to an image block 144 outside of a merge distance are excluded from being merged. For example, with reference to FIG. 12, assume that a merge distance 206 is associated with trajectories 200 and 202. If image block 144 does not lie within merge distance 206 of trajectories 200 and 202, the two trajectories are excluded from being merged. If image block 144 does lie within merge distance 206 of trajectories 200 and 202, the two trajectories are merged. In one exemplary embodiment, a merge distance of [250 pixels per second]/[frame rate] is used. As such, if the frame rate if 5 frames per second, then the merge distance is 50 pixels/frame.

One of skill in the art will appreciate that a separation distance, merge distance, and search distance used in the methods of the invention may be modified depending on the particular biological specimen to be analyzed, frame rate, image magnification, and the like. In emperically determining a search, merge, and separation distance for a given biological specimen, one of skill in the art will appreciate that the value used is based on an anticipated distance which a specimen will move between frames of the movie, and will also vary with the size of the specimen, and the speed at which the frames of the movie are acquired.

With reference to FIG. 9, in step 168, for trajectories that were not excluded in steps 164 and 166, data for the trajectories are saved. More particularly, an indication that the trajectories are merged is stored. Additionally, one or more characteristics of the image blocks 144 (FIG. 12) associated with the trajectories before being merged is saved, such as area, orientation, and/or velocity. As described below, this data can be later used to separate the trajectories. In step 170, the multiple trajectories are then merged, meaning that the merged trajectories are assigned to the common image block 144 (FIG. 12).

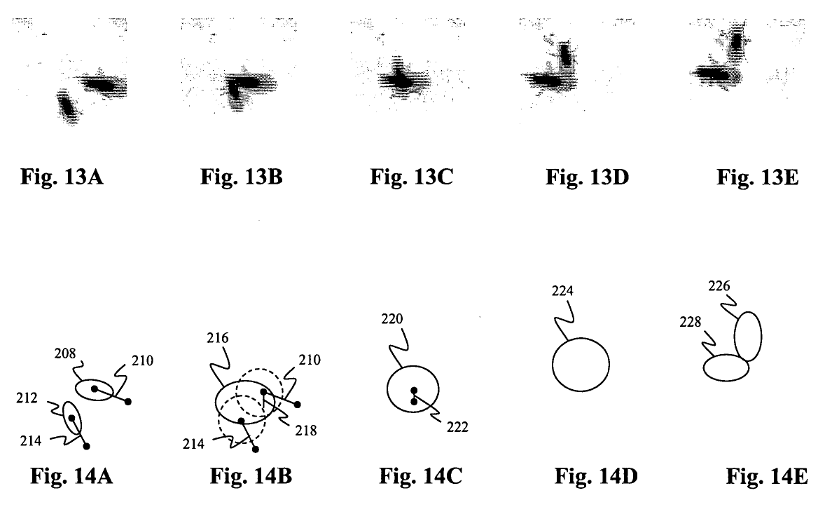

For example, FIGS. 13A to 13C depict three frames of a movie where two flies converge. Assume that FIGS. 14A to 14C depict binary images of the frames depicted in FIGS. 13A to 13C, respectively.

In FIG. 14A, two image blocks 208 and 212 are identified, which correspond to the two flies depicted in FIGS. 13A. Assume that trajectories 210 and 214 were assigned to image blocks 208 and 212, respectively, in a previous frame. As such, the data for trajectory 210 includes characteristics of image block 205, such as area, orientation, and/or velocity. Similarly, the data for trajectory 214 includes characteristics of image block 212, such as area, orientation, and/or velocity.

As depicted in FIG. 14B, assume that the two flies depicted in FIG. 13B are in sufficient proximity that in the binary image of the frame that a single image block 216 is identified. As also depicted in FIG. 14B, image block 216 lies within search distance 218 of trajectories 210 and 214. As such, image block 216 is assigned to trajectories 210 and 214. Additionally, assume that image block 216 falls within the merge distance of trajectories 210 and 214. As such, in accordance with step 168 (FIG. 9), data for trajectories 210 and 214 are saved. More specifically, one or more characteristics of image blocks 208 and 212 (FIG. 14A) are stored for trajectories 210 and 214, respectively. In accordance with step 170 (FIG. 9), trajectories 210 and 214 are merged, meaning that they are associated with image block 216.

As depicted in FIG. 14C, assume that the two flies depicted in FIG. 13C remain in sufficient proximity that in the binary image of the frame that a single image block 220 is identified. As such, trajectories 210 and 214 (FIG. 14B) remain merged. As also depicted in FIG. 14C, image block 220 can have a different shape, area, and orientation than image block 216 in FIG. 14B. Now assume that velocity vector 222 is calculated based on the change in the position of the center of image block 220 from the position of the center of image block 216 (FIG. 14B). As such, the data of the trajectory of image block 220 is appropriately updated.

Although in the above example two trajectories corresponding to two flies are merged, it should be noted that any number of trajectories corresponding to any number of flies (or any other biological specimen) can be merged. For example, rather than two flies crossing paths as depicted in FIGS. 13A to 13C, three or more flies can converge.

As noted above, with reference again to FIG. 9, in step 166, trajectories that are determined to have been unassigned trajectories in the previous frame are excluded from being merged with other trajectories. For example, with reference to FIG. 12, if trajectory 202 is determined to have been an unassigned trajectory in the previous frame, meaning that it had not been assigned to any image block 144 (FIG. 6) in the previous frame, then trajectory 202 is not merged with trajectory 200. Instead, in one embodiment, trajectory 200 is assigned to image block 144 (FIG. 6), while trajectory 202 remains unassigned.

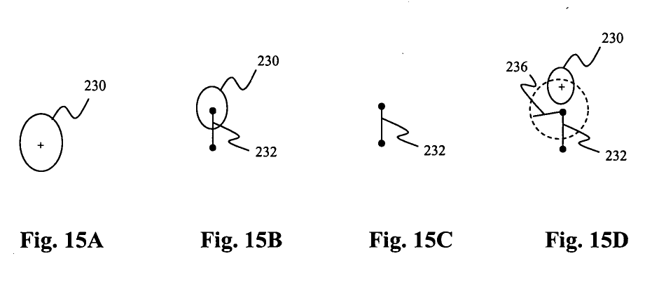

Now assume that FIGS. 15A to 15D depict the movement of a fly over four frames of a movie. More specifically, assume that during the four frames the fly begins to move, comes to a stop, and then moves again.

Assume FIG. 15A depicts the first frame. As such, a trajectory corresponding to image block 230 is initialized. As depicted in FIG. 15B, assume that the fly has moved and that image block 230 is the only image block that falls within the search distance of the trajectory that was initialized based on image block 230 in the earlier frame depicted in FIG. 15A. As such, trajectory 232 is assigned to image block 230 and the data for trajectory 232 is updated with the new location of the center, area, and orientation of image block 230. Additionally, a velocity vector is calculated based on the change in location of the center of image block 230.

Now assume that the fly comes to a stop. As described above, in one exemplary embodiment, a background approximation is calculated and subtracted from each frame of the movie. As also described above, flies that do not move throughout the movie are averaged out with the background approximation. As such, when a fly comes to a stop, the image block of that fly will decrease in area. Indeed, if the fly remains stopped, the image block can decrease until it disappears. Additionally, a fly can also physically leave the frame.

As depicted in FIG. 15C, assume in the present example that the fly has remained stopped sufficiently long enough that image block 230 (FIG. 15B) has disappeared in the present frame. As such, trajectory 232 becomes an unassigned trajectory.

Now assume that the fly begins to move again. As such, as depicted in FIG. 15D, image block 230 is identified. Now assume that the area of image block 230 is sufficiently large that image block 230 lies within search distance 236 of trajectory 232. As such, trajectory 232 now becomes assigned to image block 230.

With reference now to FIG. 9, in step 172, image blocks 144 (FIG. 6) in the current frame are examined to determine if any remain unassigned. In step 174, the unassigned image blocks are used to determine if any merged trajectories can be separated. More specifically, if an unassigned image block falls within a separation distance of a merged trajectory, one or more characteristics of the unassigned image block is compared with one or more characteristics that were stored for the trajectories prior to the trajectories being merged to determine if any of the trajectories can be separated from the merged trajectory.

For example, in one exemplary embodiment, the area of the unassigned image block can be compared to the areas of the image blocks associated with the trajectories before the trajectories were merged. As described above, this data was stored before the trajectories were merged. The trajectory with the stored area closest to the area of the unassigned image block can be separated from the merged trajectory and assigned to the unassigned image block. Alternatively, if the stored area of a trajectory and that of the unassigned image block are within a difference threshold, then that trajectory can be separated from the merged trajectory and assigned to the unassigned image block.

It should be noted that orientation or velocity can be used to separate trajectories. Additionally, a combination of characteristics can be used to separate trajectories. Furthermore, if a combination of characteristics is used, then a weight can be assigned to each characteristic. For example, if a combination of area and orientation is used, the area can be assigned a greater weight than the orientation.

As described above, FIGS. 13A to 13C depict three frames of a movie where two flies converge, and FIGS. 14A to 14C depict binary images of the frames depicted in FIGS. 13A to 13C. Similarly, FIGS. 13D and 13E depict two frames of the movie where the two flies diverge, and FIGS. 14D and 14E depict binary images of the frames depicted in FIGS. 13D and 13E.

As described above, a merged trajectory was created based on the merging of image blocks 208 and 212 (FIG. 14A) into image blocks 216 (FIG. 14B) and 220 (FIG. 14C). Assume that in FIG. 14D, the merged trajectories remain merged for image block 224. However, in FIG. 14E, assume that the flies have separated sufficiently that an image block 226 is identified apart from image block 228. Additionally, assume that in the frame depicted in FIG. 14E image block 226 is not assigned to a trajectory, but falls within the separation distance of the merged trajectory. As such, in accordance with step 174, one or more characteristics of image block 226 is compared with the stored data of the merged trajectories. More specifically, in accordance with the exemplary embodiment described above, the area of image block 226 is compared with the stored areas of image blocks 208 and 212 (FIG. 14A), which correspond to the image blocks that were associated with trajectories 210 and 214 (FIG. 14B), respectively, before the trajectories were merged. In this example, the stored area image block 212 (FIG. 14A), which corresponds to trajectory 214 (FIG. 14B) before it was merged with trajectory 210 (FIG. 14B), most closely matches the area of image block 226. As such, trajectory 214 (FIG. 14B) is separated from the merged trajectory and assigned to image block 226.

With reference again to FIG. 9, in step 178, if an unassigned image block does not fall within the separation distance of any merged trajectory, then a new trajectory is initialized for the unassigned image blocks. In one embodiment, a separation distance of 300/[frame rate], where the frame rate is the frame rate of the movie, is used. It should be noted, however, that various separation distances can be used.

In step 180, if the final frame has not been reached, then the motion tracking process loops to step 158 and the next frame is processed. If the final frame has been reached, then the motion tracking process is ended.

In this manner, with reference to FIG. 1, the movements of the biological specimens within specimen container 104 as captured by camera 124 can be processed. For example, FIG. 16 depicts the trajectories of the flies depicted in FIG. 4.

### IV. Analysis of Movement

Having thus tracked the movements of the specimens within specimen container 104, the movements can then be analyzed for various characteristics and/or traits. For example, in one embodiment, various statistics on the movements of the specimens, such as the x and y travel distance, path length, speed, turning, and stumbling, can be calculated. These statistics can be determined for each trajectory and/or averaged for a population, such as for all the specimens in a specimen container 104).

The present invention provides for the analysis of the movement of a plurality of biological specimens, and further contemplates that the measurements made of a biological specimen may additionally include other physical trait data. As used herein, “physical trait data” refers to, but is not limited to, movement trait data (e.g., animal behaviors related to locomotor activity of the animal), and/or morphological trait data, and/or behavioral trait data. Examples of such “movement traits” include, but are not limited to:

a) total distance (average total distance traveled over a defined period of time);

b) X only distance (average distance traveled in X direction over a defined period of time;

c) Y only distance (average distance traveled in Y direction over a defined period of time);

d) average speed (average total distance moved per time unit);

e) average X-only speed (distance moved in X direction per time unit);

f) average Y-only speed (distance moved in Y direction per time unit);

g) acceleration (the rate of change of velocity with respect to time);

h) turning;

i) stumbling;

j) spatial position of one animal to a particular defined area or point (examples of spatial position traits include (1) average time spent within a zone of interest (e.g., time spent in bottom, center, or top of a container; number of visits to a defined zone within container); (2) average distance between an animal and a point of interest (e.g., the center of a zone); (3) average length of the vector connecting two sample points (e.g., the line distance between two animals or between an animal and a defined point or object); (4) average time the length of the vector connecting the two sample points is less than, greater than, or equal to a user define parameter; and the like);

m) path shape of the moving animal, i.e., a geometrical shape of the path traveled by the animal (examples of path shape traits include the following: (1) angular velocity (average speed of change in direction of movement); (2) turning (angle between the movement vectors of two consecutive sample intervals); (3) frequency of turning (average amount of turning per unit of time); (4) stumbling or meandering (change in direction of movement relative to the distance); and the like. This is different from stumbling as defined above. Turning parameters may include smooth movements in turning (as defined by small degrees rotated) and/or rough movements in turning (as defined by large degrees rotated).

“Movement trait data” as used herein refers to the measurements made of one or more movement traits. Examples of “movement trait data” measurements include, but are not limited to X-pos, X-speed, speed, turning, stumbling, size, T-count, P-count, T-length, Cross150, Cross250, and F-count. Descriptions of these particular measurements are provided below.

X-Pos: The X-Pos score is calculated by concatenating the lists of x-positions for all trajectories and then computing the average of all values in the concatenated list.

X-Speed: The X-Speed score is calculated by first computing the lengths of the x-components of the speed vectors by taking the absolute difference in x-positions for subsequent frames. The resulting lists of x-speeds for all trajectories are then concatenated and the average x-speed for the concatenated list is computed.

Speed: The Speed score is calculated in the same way as the X-Speed score, but instead of only using the length of the x-component of the speed vector, the length of the whole vector is used. That is, [length]=square root of ([x-length]²+[y-length]²).

Turning: The Turning score is calculated in the same way as the Speed score, but instead of using the length of the speed vector, the absolute angle between the current speed vector and the previous one is used, giving a value between 0 and 90 degrees.

Stumbling: The Stumbling score is calculated in the same way as the Speed score, but instead of using the length of the speed vector, the absolute angle between the current speed vector and the direction of body orientation is used, giving a value between 0 and 90 degrees.

Size: The Size score is calculated in the same way as the Speed score, but instead of using the length of the speed vector, the size of the detected fly is used.

T-Count: The T-Count score is the number of trajectories detected in the movie.

P-Count: The P-Count score is the total number of points in the movie (i.e., the number of points in each trajectory, summed over all trajectories in the movie).

T-Length: The T-Length score is the sum of the lengths of all speed vectors in the movie, giving the total length all flies in the movie have walked.

Cross150: The Cross150 score is the number of trajectories that either crossed the line at x=150 in the negative x-direction (from bottom to top of the vial) during the movie, or that were already above that line at the start of the movie. The latter criteria was included to compensate for the fact that flies sometimes don't fall to the bottom of the tube. In other words this score measures the number of detected flies that either managed to hold on to the tube or that managed to climb above the x=150 line within the length of the movie.

Cross250: The Cross250 score is equivalent to the Cross150 score, but uses a line at x=250 instead.

F-Count: The F-Count score counts the number of detected flies in each individual frame, and then takes the maximum of these values over all frames. It thereby measures the maximum number of flies that were simultaneously visible in any single frame during the movie.

The assignment of directions in the X-Y coordinate system is arbitrary. For purposes of this disclosure, “X” refers to the vertical direction (typically along the long axis of the container in which the flies are kept) and “Y” refers to movement in the horizontal direction (e.g., along the surface of the vial).

For each of the various trait parameters described, statistical measures can be determined. See, for example, PRINCIPLES OF BIOSTATISTICS, second edition (2000) Mascello et al., Duxbury Press. Examples of statistics per trait parameter include distribution, mean, variance, standard deviation, standard error, maximum, minimum, frequency, latency to first occurrence, latency to last occurrence, total duration (seconds or %), mean duration (if relevant).

Certain other traits (which may involve animal movement) can be termed “behavioral traits.” Examples of behavioral traits include, but are not limited to, appetite, mating behavior, sleep behavior, grooming, egg-laying, life span, and social behavior traits, for example, courtship and aggression. Social behavior traits may include the relative movement and/or distances between pairs of simultaneously tracked animals. Such social behavior trait parameters can also be calculated for the relative movement of an animal or between animal(s) and zones/points of interest. Accordingly, “behavioral trait data” refers to the measurement of one or more behavioral traits. Examples of such social behavior trait traits include, for example, the following:

a) movement of one animal toward or away from another animal;

b) occurrence of no relative spatial displacement of two animals;

c) occurrence of two animals within a defined distance from each other;

d) occurrence of two animals more than a defined distance away from each other.

In addition to traits based on specimen movement and/or behavior, other traits of the specimens may be determined and used for comparison in the methods of the invention, such as morphological traits. As used herein, “morphological traits” refer to, but are not limited to gross morphology, histological morphology (e.g., cellular morphology), and ultrastructural morphology. Accordingly, “morphological trait data” refers to the measurement of a morphological trait. Morphological traits include, but are not limited to, those where a cell, an organ and/or an appendage of the specimen is of a different shape and/or size and/or in a different position and/or location in the specimen compared to a wild-type specimen or compared to a specimen treated with a drug as opposed to one not so treated. Examples of morphological traits also include those where a cell, an organ and/or an appendage of the specimen is of different color and/or texture compared to that in a wild-type specimen. An example of a morphological trait is the sex of an animal (i.e., morphological differences due to sex of the animal). One morphological trait that can be determined relates to eye morphology. For example, neurodegeneration is readily observed in a Drosophila compound eye, which can be scored without any preparation of the specimens (Fernandez-Funez et al., 2000, Nature 408:101-106; Steffan et. al, 2001, Nature 413:739-743). This organism's eye is composed of a regular trapezoidal arrangement of seven visible rhabdomeres produced by the photoreceptor neurons of each Drosophila ommatidium. Expression of mutant transgenes specifically in the Drosophila eye leads to a progressive loss of rhabdomeres and subsequently a rough-textured eye (Femandez-Funez et al., 2000; Steffan et. al, 2001). Administration of therapeutic compounds to these organisms slows the photoreceptor degeneration and improves the rough-eye phenotype (Steffan et. al, 2001). In one embodiment, animal growth rate or size is measured. For example Drosophila mutants that lack a highly conserved neurofibromatosis-1 (NF1) homolog are reduced in size, which is a defect that can be rescued by pharmacological manipulations that stimulate signalling through the cAMP-PKA pathway (The et al., 1997, Science 276:791-794; Guo et al., 1997, Science 276:795-798).

Traits exhibited by the populations may vary, for example, with environmental conditions, age of a specimen and/or sex of a specimen. For traits in which such variation occurs, assay and/or apparatus design can be adjusted to control possible variations. Apparatus for use in the invention can be adjusted or modified so as to control environmental conditions (e.g., light, temperature, humidity, etc.) during the assay. The ability to control and/or determine the age of a fly population, for example, is well known in the art. For those traits which have a sex-specific bias or outcome, the system and software used to assess the trait can sort the results based a detectable sex difference in of the specimens. For example, male and female flies differ detectably in body size. Thus, analysis of sex-specific traits need not require separated male and/or female populations. However, sex-specific populations of specimens can be generated by sorting using manual, robotic (automated) and/or genetic methods as known in the art. For example, a marked-Y chromosome carrying the wild-type allele of a mutation that shows a rescuable maternal effect lethal phenotype can be used. See, for example, Dibenedetto et al. (1987) Dev. Bio. 119:242-251.

In the present embodiment, x and y travel distances can be determined based on the tracked positions of the centers of image blocks 144 (FIG. 6) and/or the velocity vectors of the trajectories. As noted above, the x and y travel distance for each trajectory can be determined, which can indicate the x and y travel distance of each specimen within specimen container 104. Additionally or alternatively, an average x and y travel distance for a population, such as all the specimens in a specimen container 104, can be determined.

Path length can also be determined based on the tracked positions of the centers of image blocks 144 (FIG. 6) and/or the velocity vectors of the trajectories. Again, a path length for each trajectory can be determined, which can indicate the path length for each specimen within specimen container 104. Additionally or alternatively, an average path length for a population, such as all the specimens in a specimen container 104, can be determined.

Speed can be determined based on the velocity vectors of the trajectories. An average velocity for each trajectory can be determined, which can indicate the average speed for each specimen within specimen container 104. Additionally or alternatively, an average speed for a population, such as all the specimens in a specimen container 104, can be determined.

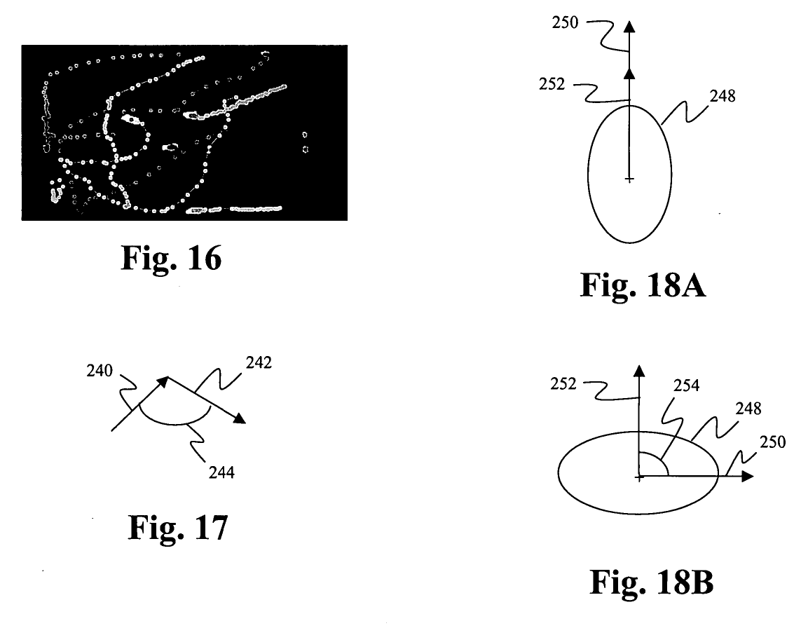

Turning can be determined as the angle between two velocity vectors of the trajectories. As used herein, “turning” refers to a change in the direction of the trajectory of a specimen such that a second trajectory is different from a first trajectory. Turning may be determined by detecting the existence of an angle 374 between the velocity vector of a first frame and a second frame. More specifically, “turning” may be determined herein as an angle 374 of at least 1⁰, preferably greater than 2⁰, 5⁰, 10⁰, 20⁰, 30⁰, 40⁰, 50⁰, and up to or greater than 90⁰. For example, with reference to FIG. 17, assume that velocity vector 240 was determined based on the movement of a specimen between frames 1 and 2; and velocity vector 242 was determined based on the movement of the specimen between frames 2 and 3. As such, in this example, angle 244 defines the amount of turning captured in frames 1, 2, and 3. In this manner, the amount of turning for each trajectory can be determined, which can indicate the amount of turning for each specimen within specimen container 104. Additionally or alternatively, an average amount of turning for a population, such as all the specimens in a specimen container 104, can be determined.

Stumbling can be determined as the angle between the orientation of a image block 144 (FIG. 6) and the velocity vector of the image block 144 (FIG. 6) of the trajectories. Accordingly, “stumbling” as used herein refers to a difference between the direction of the orientation vector and the velocity vector of a biological specimen. “Stumbling” may be determined according to the invention, by the presence of an angle between the orientation vector and velocity vector of a biological specimen of at least 1⁰, preferably greater than 2⁰, 5⁰, 10⁰, 20⁰, 40⁰, 60⁰, and up to or greater than 90⁰. For example, with reference to FIG. 18A, assume that orientation 250 and velocity vector 252 of an image block 248 of a trajectory are aligned (i.e., the angle between orientation 250 and velocity vector 252 is zero degrees). As such, in this instance, the amount of stumbling is zero, and thus at a minimum. With reference to FIG. 18B, now assume that orientation 250 and velocity vector 252 of image block 248 of a trajectory are perpendicular (i.e., the angle between orientation 250 and velocity vector 252 is 90 degrees). As such, in this instance, amount of stumbling defined by angle 254 is 90 degrees, and thus at a maximum. In this manner, the amount of stumbling for each trajectory can be determined, which can indicate the amount of stumbling for each specimen within specimen container 104. Additionally or alternatively, an average amount of stumbling for a population, such as all the specimens in a specimen container 104, can be determined.

### V. Assaying System Alternate Embodiments

Certain embodiments of the present invention may comprise a system or method of assaying plural biological specimens, or any given submethod or subsystem thereof, wherein “plural”, as used herein refers to more than one individual specimen (i.e., 2 or more, 5 or more, 10 or more, 20 or more, 30 or more, 50 or more, and up to or greater than 100 or more). Each of the biological specimens moves within a field of view of a camera. In such a system or method, plural multi-pixel target images of a field of view are obtained at different corresponding points in time over a given sample period. A background image is obtained using a plural set of the plural target images. For a range of points in time, the background image is removed from the target images to produce corresponding background—removed target images. Analysis is performed using at least a portion of the corresponding background-removed target images to identify visible features of the biological specimens.

The plural biological specimens may comprise sets of biological specimens provided in discrete containers. Some of the containers may comprise a reference population of biological specimens and other of the containers may comprise a test population of biological specimens. The discrete containers may comprise transparent vials or plates. Each of the sets of biological specimens may comprise plural specimens within a discrete container.

The biological specimens may comprise Drosophila within transparent tubes. The field of view may encompass an entire area within each of the containers that is visible to a camera, and in the illustrated embodiment, the field of view captures at least a region of interest.

Obtaining of a background image may comprise normalizing non-moving elements in the plural mutli-pixel target images, where the plural multi-pixel target images comprise frames of a movie. Alternatively, obtaining a background image may comprise removing objects from the target images by normalizing non-moving elements in the target images. The normalizing may comprise averaging images among a plural set of the target images.

The obtaining of a background may comprise superimposing two or more of the target images, and then determining a characteristic pixel value for the pixels in the superimposed target images. The characteristic pixel values may comprise averaged pixel values from corresponding pixels from among the plural set of target images. The characteristic pixel values may comprise median pixel values from corresponding pixels from among the plural set of target images. The plural set may comprise all of the images taken during the given sample.

Removing the background image from the target images may comprise calculating a difference between the target images and the background image. The method may comprise further processing the background—removed target images to produce a filtered binary image. The further processing may comprise applying a gray-scale threshold to the background-removed target images. The method may comprise further processing the background-removed target images by identifying image blocks and by removing image blocks that are larger than a maximum threshold size and smaller than a minimum threshold size. The maximum threshold size may comprise a maximum threshold area, and the minimum threshold size may comprise a minimum threshold area.

The performing analysis may comprise determining a trajectory of the specimens within each of the plural sets of specimens. The trajectory is based upon information including the orientation of a given image block representing a given specimen, the center of the given image block, the area of the given image block, and a velocity vector representing the velocity of the given image block.

The performing analysis may comprise determining an orientation of the specimens. The performing analysis may comprise determining a predicted position of a given image block representing a given specimen based on previous position information regarding the given image block plus a prediction factor multiplied by a previous velocity vector. The prediction factor, in the illustrated embodiment, is between 0 and 1.

The performing analysis may comprise determining a velocity of the specimens. The performing analysis may comprise distinguishing a given specimen from other specimens so behavioral statistics can be correctly attributed to the given specimen. The performing analysis may comprise calculating travel distances of the specimens. The travel distance may be calculated after specimens are caused to move in response to stimulation of the specimens. The specimens are stimulated by subjecting them to an attraction. The containers containing the specimens may be moved to cause the specimens to move to a repeatable reference position, and the specimens may be attracted toward a given different position with light.

The performing analysis may comprise calculating a path length of the path traveled by the specimens. The performing analysis may comprise calculating a speed of the specimens. The performing analysis may comprise calculating turning of the specimens.

The calculating turning of a specimen comprises calculating an angle between a velocity vector of a given trajectory of a specimen and the subsequent velocity vector of the same trajectory of the same specimen.

The performing analysis may comprise calculating stumbling of a given specimen. The calculating stumbling may comprise determining an angle between an orientation of an image block representing the specimen and a velocity vector of the image block. The analysis may be performed on every specimen of the specimen's assayed.

In accordance with another embodiment, a system is provided for assaying specimens. Alternatively, this embodiment may be directed to a method for assaying specimens. The invention may be directed to any subsystem or submethod of such system and method.

The system comprises a holding structure to hold a set of discrete specimen containers, and a positioning mechanism. The positioning mechanism positions a plural subset of the containers to place the moving specimens within the plural subset of the containers within a field of view of the camera. The plural specimens may comprise sets of specimens provided in respective, discrete containers. Some of the containers comprise a reference population of specimens and other of the containers comprises a test population of specimens. The field of view may encompass the entire area within the containers of the plural subset as visible to a camera. The field of view may encompass a region of interest. In the illustrated embodiment, the field of view of one camera covers specimens of the plural subset. Alternatively, one camera field of view may correspond to one container within the plural subset. The containers of the plural subset may be moved to an imaging position of an imaging station. The positioning mechanism may comprise a conveyor to move containers of the plural subset to an imaging position of an imaging station.

The positioning mechanism may comprise a staging mechanism to move containers through positioned stages. Movement from one stage to another results in drosophila being forced to a reference position. Each stage corresponds to the containers being at an imaging position of an imaging station. The reference position may be the bottom of the container.

The system may be further provided with an identification mechanism to automatically identify each container. The identification mechanism may comprise an identifier provided on each container, and an identifier reader within a positioning path between a resting position of the container and the imaging position of the container. The identifier may comprise a barcode provided on each of the containers, and the identifier reader may comprise a barcode scanner. Identifier information is included within the class of “sample data” which is specific for each sample comprising plural biological specimens analyzed according to the invention. “Sample data” as used herein, refers to information or data which relates to each specimen in a sample, and includes but is not limited to, specimen type (e.g., animal, Drosophila), sex, age, genotype, whether the specimens are wild-type (reference sample) or transgenic (test sample), sample size, whether the specimens in the sample have been exposed to a candidate agent, and the like.

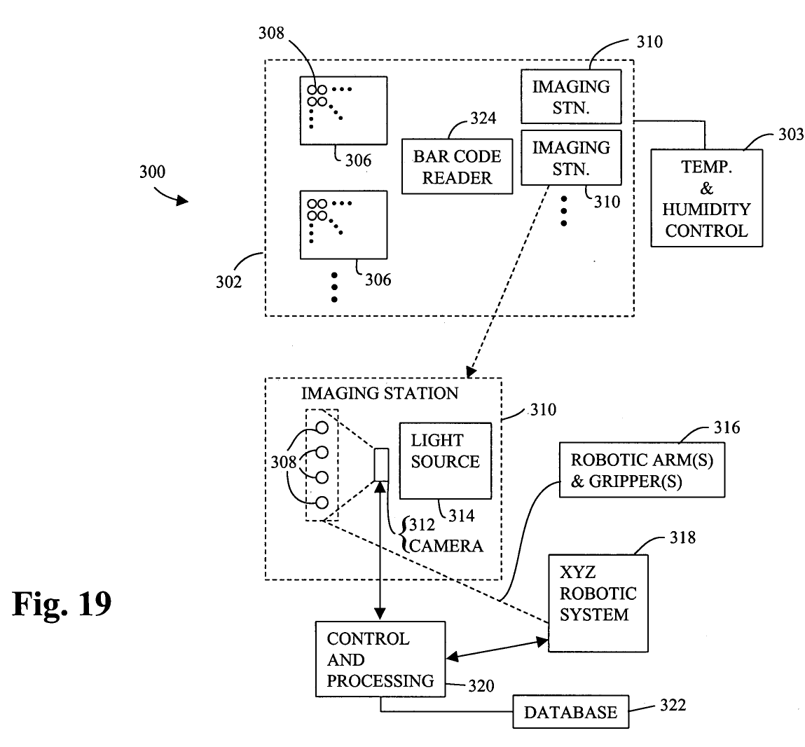

FIG. 19 is a block diagram of a second embodiment assaying system 300. In the illustrated embodiment, assaying system comprises 300 a housing/support structure 302, which supports plural container trays 306 (4 trays in the illustrated embodiment). A temperature and humidity control system 303 is provided to control the temperature and humidity within housing 302. A bar code reader 324 is provided to facilitate the reading of the identification of individual containers 308 of the trays. In the illustrated embodiment, containers 308 comprise vials, although they may be other types of containers—e.g., plates.

The system has a plurality of imaging stations 310 (e.g., 4 such stations). Having a number of imaging stations allows the concurrent imaging of different sets of containers 308, for increased throughput in collecting data.

FIG. 19 shows a top view of a given imaging station. Each imaging station 310 comprises a place to receive a set of containers 308, a camera head 312, and a light source 314. In the illustrated embodiment, a set (e.g., 4) of containers 308 is removed from its tray (or from separate, respective trays) 306 and placed within the field of view of a camera 312 by a robotic arm/gripper (or a plurality of such arms/grippers). Camera 312 takes an image of the set of containers 308, and is adjusted and focused to produce images of the specimens within each of the containers, with the requisite resolution in the field of view. A light source 314 is provided to provide front lighting for the imaging. In addition, light source 314 is positioned and configured to provide light at a high point near the containers 308.

The illustrated embodiment contemplates use with drosophila, although it will be recognized by one of skill in the art that the methods described herein may be adapted for use with any biological specimen within the scope of the invention, and the containers of fruit flies are stimulated by gently moving the containers in a downward direction. This causes the fruit flies to fall to the bottom of the container. Meanwhile, the light, positioned above the containers attracts the flies toward to the top of the container.

An XYZ robotic system 318 is provided, and may comprise a custom-built or commercially available movement control system, capable of controlling the movement of one or more robotic arms or grippers.

Pictures captured by camera 312 are stored in a database 322 by control and processing system 320. Control and processing system 320 also controls the operation of robotic system 318. System 320 may comprise, e.g., a PC computer, controller software, a Windows® OS, a screen, mouse, and keyboard, a set of motion control cards, and a set of frame grabber cards.

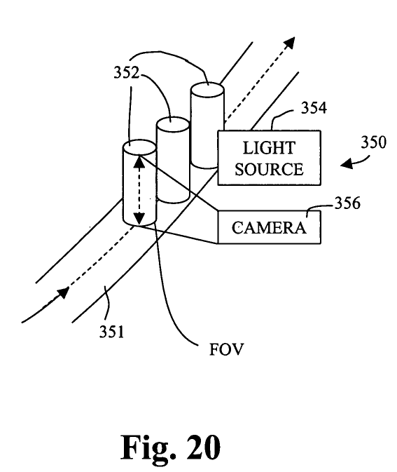

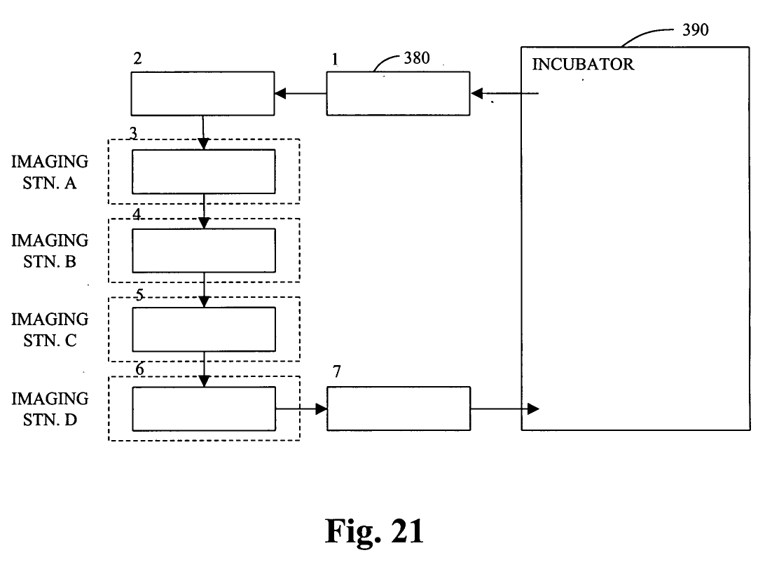

In FIG. 19, it is contemplated that the containers (vials in the illustrated embodiment) are kept in trays 308 (e.g., 96 vial racks), mounted onto a table and located on the table in such a manner to facilitate ready-access for movement of vials to and from imaging stations 310. FIGS. 20 and 21 show alternate ways of implementing imaging stations and of moving the containers to and from the imaging positions.

FIG. 20 is a simplified perspective view of an imaging station 350, which involves moving vials 352 along a conveyor 351. A camera 356 and light source 354 are provided adjacent the conveyor. Camera 356 may have a field of view that corresponds to a single vial, or it may capture a plurality of vials.

FIG. 21 is a simplified side view of a staged imaging station approach. A plurality of specimen containers are positioned in racks. For example, a given rack 380 may comprise a single row of 10 vertically positioned vials, and have a structure such that the vials and their contents are visible. The racks are kept in an incubator 390, and moved vertically through positioned stages during an assay. At a first position (1), a rack 380 is out of incubator 390. At a second position (2), it is ready to be lowered to third position (3). In the process of lowering the rack to third position (3) (imaging station A), the specimens (flies in the embodiment) are gently forced to the bottom of the vials. Light can be provided at the top of each imaging station, so that the flies try to reach the top of the vial. The flies are imaged at the first imaging station (imaging station A at position (3)), and physical trait data (including, but not limited to movement trait data, behavioral trait data, and morphological trait data) regarding the flies is acquired. Then, the rack is lowered again to position (4) (imaging station B). This process is repeated through the next stages (i.e., positions 5 and 6), before the rack is returned to the incubator via position 7.

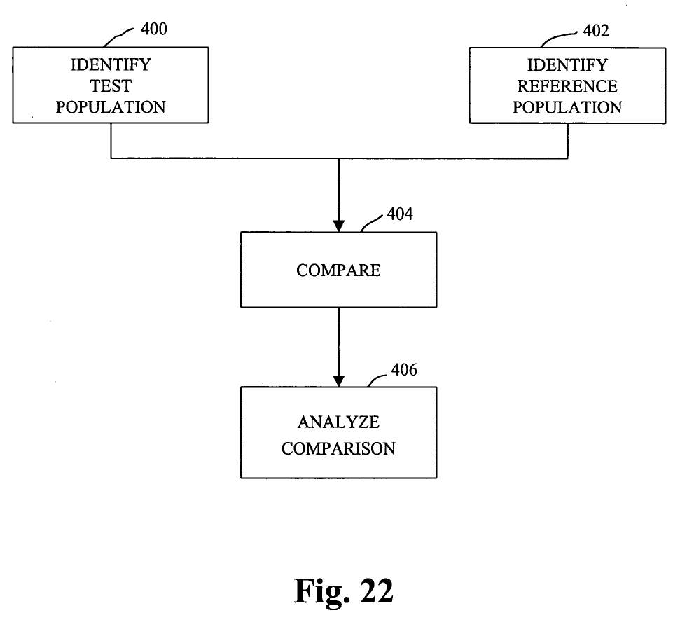

FIG. 22 shows an animal population comparison process for assessing a condition or treatment of a condition, involving a test population and a reference population. In acts 400 and 402, test population data and reference population data are obtained, respectively.

In one embodiment, the test population comprises an animal population with a central nervous system condition, and the reference population does not have the condition. More specifically, e.g., the test population has a gene predisposing it to a central nervous system condition, and the reference does not have this gene. Both populations are given a treatment before the data set is obtained.

In another embodiment, the test population is given a treatment for a central nervous system condition and the reference is not given the treatment.

In act 404, the data sets from the test and reference populations are compared, and the comparison is analyzed in act 406.

In one embodiment, the analysis in act 406 uses a threshold value to determine if there is a difference between the test and reference populations. For example, if the test population has a central nervous system condition and the reference does not, then if the differential of motion traits between the two populations is above a specified threshold, those motion traits can be considered to indicate the presence of the central nervous system condition afflicting the test population.

### EXAMPLES

The examples below (Examples 1-3) were performed using the following score definitions.

Each movie is first scored individually to give one value per score and movie. A single movie is therefore considered to be the experimental base unit. Thereafter average values and standard errors for all scores are calculated from the movie score values for all repeats for a vial. Those averages and standard errors are the values shown in the PhenoScreen program. The data that is used in the scoring process are the trajectories of the corresponding movie. Each trajectory comprises of a list of x- and y-coordinates of the position of the fly (and also size), with one list entry for every frame from when it starts moving in one frame until it stops in another.

Score definitions are as follows. The data corresponding to each score is a measure of “movement trait data”:

X-Pos: The X-Pos score is calculated by concatenating the lists of x-positions for all trajectories and then computing the average of all values in the concatenated list.

X-Speed: The X-Speed score is calculated by first computing the lengths of the x-components of the speed vectors by taking the absolute difference in x-positions for subsequent frames. The resulting lists of x-speeds for all trajectories are then concatenated and the average x-speed for the concatenated list is computed.

Speed: The Speed score is calculated in the same way as the X-Speed score, but instead of only using the length of the x-component of the speed vector, the length of the whole vector is used. That is, [length]=square root of ([x-length]²+[y-length]²).

Turning: The Turning score is calculated in the same way as the Speed score, but instead of using the length of the speed vector, the absolute angle between the current speed vector and the previous one is used, giving a value between 0 and 90 degrees.

Stumbling: The Stumbling score is calculated in the same way as the Speed score, but instead of using the length of the speed vector, the absolute angle between the current speed vector and the direction of body orientation is used, giving a value between 0 and 90 degrees.

Size: The Size score is calculated in the same way as the Speed score, but instead of using the length of the speed vector, the size of the detected fly is used.

T-Count: The T-Count score is the number of trajectories detected in the movie.

P-Count: The P-Count score is the total number of points in the movie (i.e., the number of points in each trajectory, summed over all trajectories in the movie).

T-Length: The T-Length score is the sum of the lengths of all speed vectors in the movie, giving the total length all flies in the movie have walked.

Cross150: The Cross150 score is the number of trajectories that either crossed the line at x=150 in the negative x-direction (from bottom to top of the vial) during the movie, or that were already above that line at the start of the movie. The latter criteria was included to compensate for the fact that flies sometimes don't fall to the bottom of the tube. In other words this score measures the number of detected flies that either managed to hold on to the tube or that managed to climb above the x=150 line within the length of the movie.

Cross250: The Cross250 score is equivalent to the Cross150 score, but uses a line at x=250 instead.

F-Count: The F-Count score counts the number of detected flies in each individual frame, and then takes the maximum of these values over all frames. It thereby measures the maximum number of flies that were simultaneously visible in any single frame during the movie.

### Example 1

### Motion Tracking With Wild-Type Flies

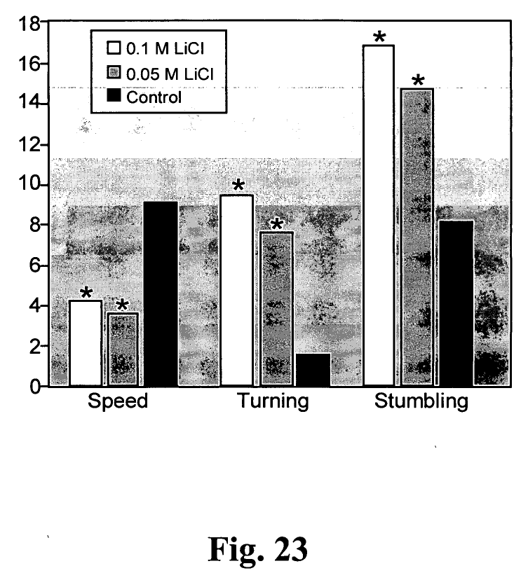

Several sets of wild-type flies were assayed under various conditions to test the motion tracking software. Lithium Chloride (LiCl), a treatment for bipolar affective disorder in humans, is also known to induce behavioral changes in Drosophila (Xia et al., 1997). In this assay, flies fed 0.1M or 0.05M LiCl exhibited a significant reduction in speed and an increased incidence of turning and stumbling compared to controls. The results of this assay are shown in the bar graph of FIG. 23.

### Example 3

### Motion Tracking With Drosophila Model of Huntington Disease

Drosophila expressing a mutant form of human Huntington (HD) have a functional deficit that is quantifiable, reproducible, and is suitable for automated high-throughput screening. Drosophila (or specimen) movements can be analyzed for various characteristics and/or traits. For example, statistics on the movements of the specimens, such as the x and y travel distance, path length, speed, turning, and stumbling, can be calculated. These statistics can be averaged for a population and plotted.

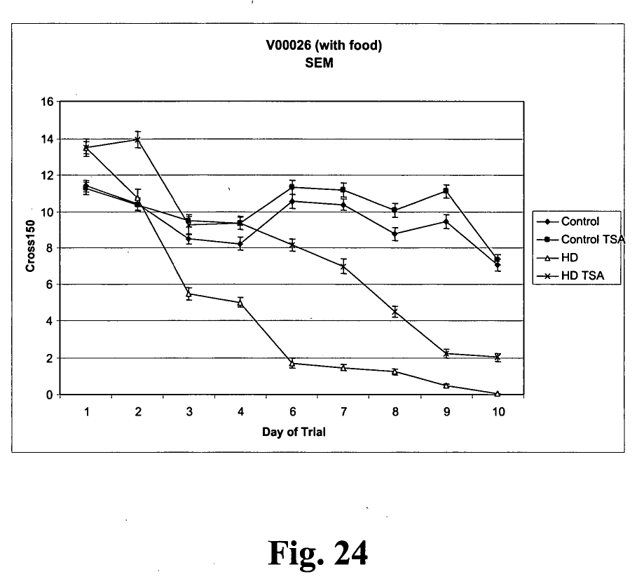

Differences between the HD model ± drug (HDAC inhibitor, TSA) and wild type (control) ± drug (TSA) can clearly be detected using the motion tracking software. Progressive motor dysfunction and therapeutic treatment with drug can be measured by various scoring parameters. Such results are shown in FIG. 24. In FIG. 24, motor performance, assessed by the Cross150 score, is plotted on the y-axis against time (x-axis). The Cross150 score, or x travel distance, is equal to the number of trajectories (specimens) that cross a position at x=150 in the negative x-direction (from bottom to top of the vial) during the movie. In other words, this score measures the number of detected flies that climb above the x=150 line within the length of the movie. This graph demonstrates the potential therapeutic effect of drug (TSA) on the HD model. Error bars are ± SEM). Control genotype is yw/elavGAL4. HD genotype is HD/elavGAL4.

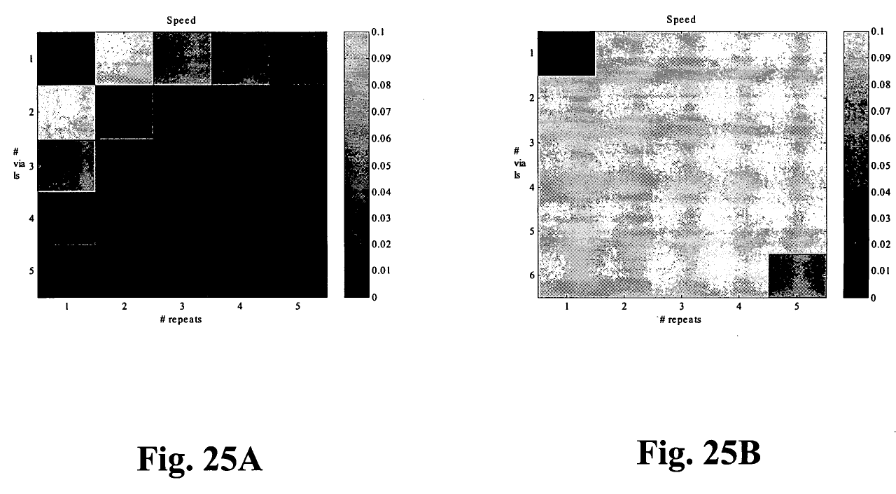

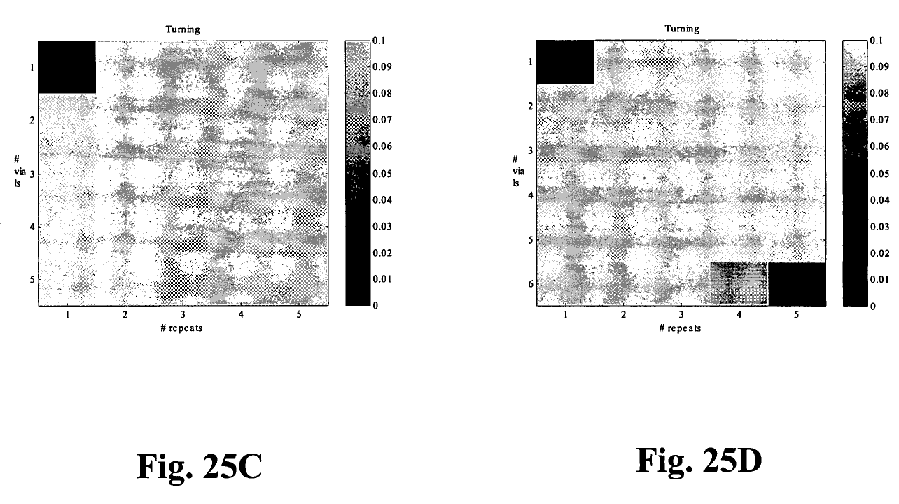

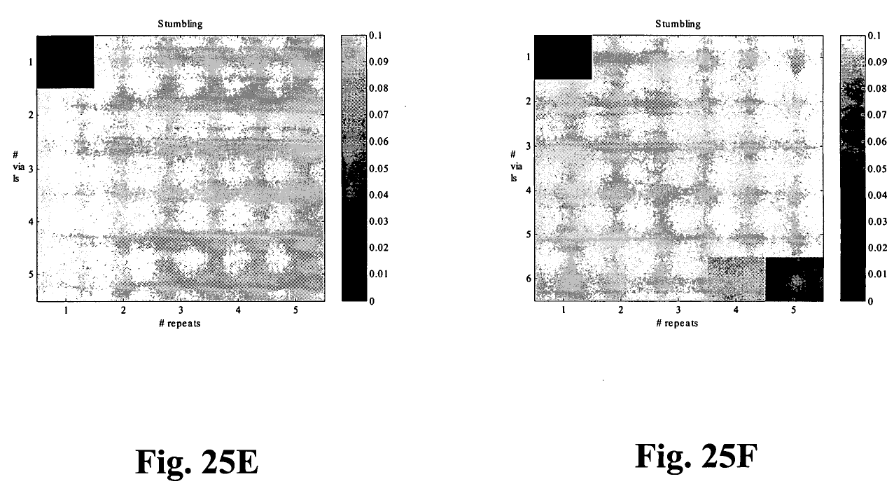

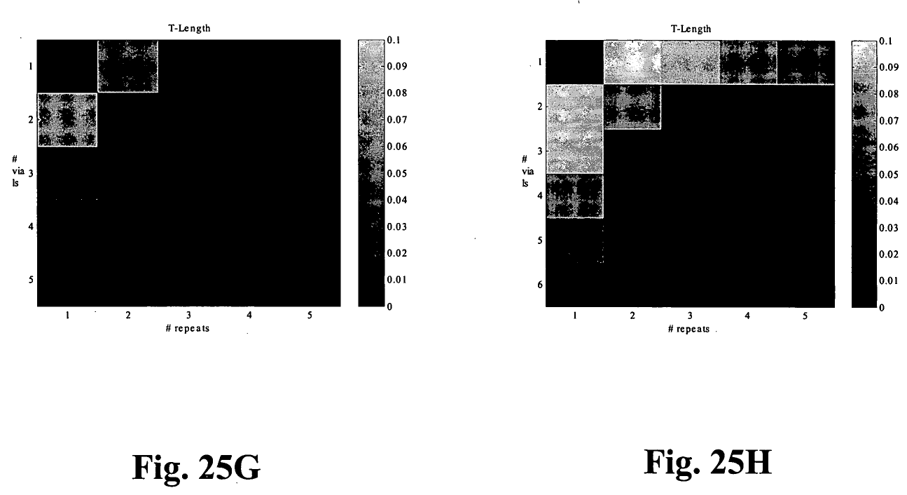

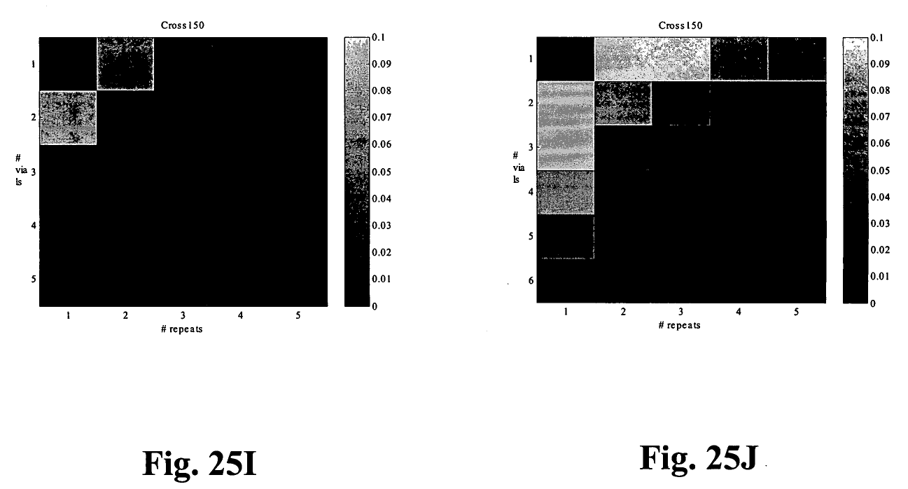

Movement characteristics of different models, or the effects of certain drugs on those models, will be distinct. FIGS. 25A-25J demonstrate (1) how well various scores define the differences between disease model and wild-type control, (2) how well the various scores detect improvements ± drug treatment, and (3) how many replica vials and repeat videos are needed for statistically significant results. In FIGS. 25A-25J, the average p-values for each combination of a certain number of video repeats and replica vials for Test and Reference populations are shown. Lower -values are indicated by darker coloring. The lower the p-value, the more likely the score represents a significant difference between Test and Reference populations. In FIGS. 25A, 25C, 25E, 25G, and 251, the Reference population is wild-type control and the Test population is the HD model. In FIGS. 25B, 25D, 25F, 25H, and 25J, the Reference population is HD model without drug and the Test population is the HD model with drug (TSA). Speed is shown in FIGS. 25A and 25B, turning is shown in FIGS. 25C and 25D, stumbling is shown in FIGS. 25E and 25F, T-length is shown in FIGS. 25G and 25H, and Cross 150 is shown in FIGS. 25I and 25J.

In FIGS. 25A, 25G and 25I, Speed, T-Length, and Cross150 scores are very useful for identifying HD flies from wild-type control flies—the p-value goes down when either number of replica vials or number of repeat videos are increased, which is to be expected. Turning and Stumbling scores do not appear do give significant values not even for large number of replica vials or videos repeats. In FIGS. 25B, 25D and 25F, the scores for Speed, Turning, and Stumbling do not yield significant values. The scores that best highlight the therapeutic effect of the drug in the HD model are T-Length (FIGS. 25G and 25H) and Cross150 (FIGS. 251 and 25J). Note the striking differences between the Speed plots (FIGS. 25A and 25B). Speed is a useful score for telling apart HD flies from wild type flies, however it does not appear to be effective for telling apart HD untreated flies from HD with drug flies. Although the drug seems to restore climbing ability for HD flies to almost the same level as for wt flies, the same is not true for speed.

### Example 4

### Motion Tracking With Drosophila Model of Spinocerebellar Ataxia Type 1

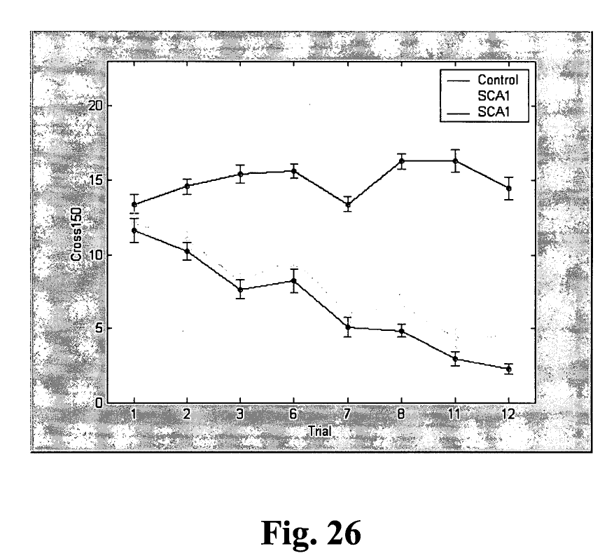

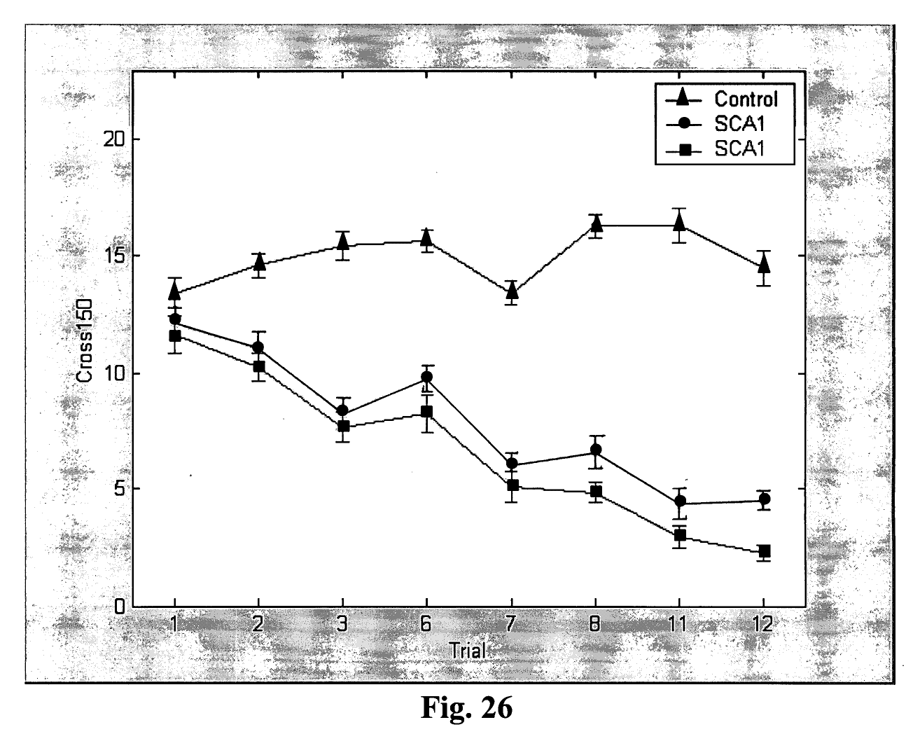

FIG. 26 shows the loss of motor performance in the SCA1 Drosophila model. SCA1 model and control trials were analyzed and plotted by Phenoscreen software. Motor performance on the y-axis (Cross150) is plotted against time on the x-axis (Trials). SCA1 model is indistinguishable from controls on first day of adult life then they decline progressively in climbing ability. The error bars are ± SEM. Control fly genotype is yw/nirvanaGAL4. SCA1 fly genotype is SCA1/nirvanaGAL4.

What is claimed is:

1. A method for assaying plural biological specimens, each of the biological specimens moving within a field of view, the method comprising:
obtaining plural multi-pixel target images of the field of view at different corresponding points in time over a given sample period;
obtaining a background image using a plural set of the plural target images;
for a range of points in time, removing the background image from the target images to produce corresponding background-removed target images; and
performing analysis using at least a portion of the corresponding background-removed target images to identify visible features of the biological specimens.

2. The method according to claim 1, wherein the plural biological specimens comprise sets of biological specimens provided in discrete containers, some of the containers comprising a reference population of biological specimens and other of the containers comprising a test population of biological specimens.

3. The method according to claim 2, wherein the discrete containers comprise transparent vials.

4. The method according to claim 2, wherein the discrete containers comprise plates.

5. The method according to claim 1, wherein each of the sets of biological specimens comprises plural specimens within a discrete container.

6. The method according to claim 5, wherein the specimens comprise animals within transparent tubes.

7. The method according to claim 5, wherein the specimens comprise flies within transparent tubes.

8. The method according to claim 5, wherein the specimens comprise drosophila within transparent tubes.

9. The method according to claim 1, wherein the field of view encompasses an entire area within each of the containers that is visible to a camera.

10. The method according to claim 9, wherein the field of view captures at least a region of interest.

11. The method according to claim 1, wherein the obtaining of a background image comprises normalizing non-moving elements in the plural multi-pixel target images, the plural multi-pixel target images comprising frames of a movie.

12. The method according to claim 1, wherein the obtaining of a background image comprises removing objects from the target images by normalizing non-moving elements in the target images.

13. The method according to claim 12, wherein the normalizing comprises averaging images among a plural set of the target images.

14. The method according to claim 1, wherein the obtaining of a background image comprises superimposing two or more of the target images, and then determining a characteristic pixel value for the pixels in the superimposed target images.

15. The method according to claim 14, wherein the characteristic pixel values comprise averaged pixel values from corresponding pixels from among the plural set of target images.

16. The method according to claim 14, wherein the characteristic pixel values comprise median pixel values from corresponding pixels from among the plural set of target images.

17. The method according to claim 1, wherein the plural set comprises all of the images taken during the given sample period.

18. The method according to claim 1, wherein the removing of a background image from the target images comprises calculating a difference between the target images and the background image.

19. The method according to claim 1, further comprising further processing the background-removed target images to produce a filtered binary image.

20. The method according to claim 17, wherein the further processing comprises applying a gray-scale threshold to the background-removed target images.

21. The method according to claim 1, further comprising further processing the background-removed target images by identifying image blocks and by removing image blocks that are larger than a maximum threshold size and smaller than a minimum threshold size.

22. The method according to claim 21, wherein the maximum threshold size comprises a maximum threshold area, and wherein the minimum threshold size comprises a minimum threshold area.

23. The method according to claim 1, further comprising further processing the background-removed target images by identifying an eccentricity value for an image block and then removing image blocks that are larger than double the eccentricity value or smaller than half the eccentricity value.

24. The method according to claim 1, wherein the performing analysis comprises determining a trajectory of the biological specimens within each of the plural sets of biological specimens, the trajectory being based upon information including the orientation of a given image block representing a given biological specimen, the center of the given image block, the area of the given image block, and a velocity vector representing the velocity of the given image block.

25. The method according to claim 1, wherein the performing analysis comprises determining an orientation of the biological specimens.

26. The method according to claim 1, wherein the performing analysis comprises determining a predicted position of a given image block representing a given specimen based on previous position information regarding the given image block plus a prediction factor multiplied by a previous velocity vector.

27. The method according to claim 26, wherein the prediction factor is between zero and one.

28. The method according to claim 1, wherein the performing analysis comprises distinguishing a given specimen from other biological specimens so behavioral statistics can be correctly attributed to the given biological specimen.

29. The method according to claim 1, wherein the performing analysis comprises calculating travel distances of the biological specimens.

30. The method according to claim 29, wherein the travel distance is calculated after the biological specimens are caused to move in response to stimulation of the biological specimens.

31. The method according to claim 30, wherein the biological specimens are stimulated by subjecting them to an attraction.

32. The method according to claim 31, wherein the containers containing the specimens are moved to cause the biological specimens to move to a repeatable reference position, and wherein the biological specimens are attracted toward a given different position with light.

33. The method according to claim 1, wherein the performing analysis comprises calculating a path length of the path traveled by the specimens.

34. The method according to claim 1, wherein the performing analysis comprises calculating a speed of the biological specimens.

35. The method according to claim 1, wherein the performing analysis comprises calculating turning of the biological specimens.

36. The method according to claim 35, wherein the calculating turning of a biological specimen comprises calculating an angle between a velocity vector of a given trajectory of a biological specimen and the subsequent velocity vector of the same trajectory of the same biological specimen.

37. The method according to claim 1, wherein the performing analysis comprises calculating stumbling of a given biological specimen.

38. The method according to claim 37, wherein calculating stumbling comprises determining an angle between an orientation of an image block representing the biological specimen and a velocity vector of the image block.

39. The method according to claim 1, wherein the analysis is performed on every biological specimen of the biological specimens assayed.

40. A system for assaying plural biological specimens, each of the biological specimens moving within a field of view, the system comprising:
a holding structure to hold a set of discrete specimen containers; and
a positioning mechanism to position a plural subset of the containers to place the moving biological specimens within the plural subset of the containers within a field of view of a camera.

41. The system according to claim 40, wherein the plural biological specimens comprise sets of biological specimens provided in respective discrete containers, some of the containers comprising a reference population of biological specimens and other of the containers comprising a test population of biological specimens.

42. The system according to claim 41, wherein the discrete containers comprise transparent vials.

43. The system according to claim 41, wherein the discrete containers comprise plates.

44. The system according to claim 41, wherein each of the sets of specimens comprises plural biological specimens within a discrete container.

45. The system according to claim 44, wherein the biological specimens comprise animals within a transparent tube.

46. The system according to claim 44, wherein the biological specimens comprise flies within a transparent tube.

47. The system according to claim 44, wherein the biological specimens comprise drosophila within a transparent tube.

48. The system according to claim 40, wherein the field of view encompasses the entire area within the containers of the plural subset as visible to a camera.

49. The system according to claim 48, wherein the field of view encompasses a region of interest.

50. The system according to claim 40, wherein the holding structure comprises at least one tray of discrete specimen containers.

51. The system according to claim 40, wherein the field of view of one camera covers specimens of the plural subset.

52. The system according to claim 40, wherein one camera field of view corresponds to one container within the plural subset.

53. The system according to claim 40, wherein the containers of the plural subset are moved to an imaging position of an imaging station.

54. The system according to claim 40, wherein the positioning mechanism comprises a conveyor to move containers of the plural subset to an imaging position of an imaging station.

55. The system according to claim 40, wherein the positioning mechanism comprises a staging mechanism to move containers through positioned stages, movement from one stage to another resulting in the biological specimens being forced to a reference position, each stage corresponding to the containers being at an imaging position of an imaging station.

56. The system according to claim 55, wherein the reference position is the bottom of the container.

57. The system according to claim 40, further comprising an identification mechanism to automatically identify each container.

58. The system according to claim 57, wherein the identification mechanism comprises an identifier provided on each container, and comprises an identifier reader within a positioning path between a resting position of the container and the imaging position of the container.

59. The system according to claim 58, wherein the identifier comprises a bar code provided on each of the containers, and wherein the identifier reader comprises a bar code scanner.

60. A method of processing frames of a digitized movie comprising:
superimposing frames of the movie to obtain a background approximation; and
determining characteristic pixel values for pixels of the background approximation based on pixels of the superimposed frames.

61. The method of 60, wherein superimposing frames comprises superimposing all of the frames of the movie.

62. The method of 60, wherein superimposing frames comprises superimposing a set of frames of the movie.

63. The method of 60, wherein the characteristic values are average pixel values based on pixel values of the superimposed frames.

64. The method of 60, wherein the characteristic values are median pixel values based on pixel values of the superimposed frames.

65. The method of 60, further comprising:
subtracting the background approximation from a frame.

66. The method of 65, further comprising:
applying a gray scale threshold to create a binary image of the frame.

67. The method of 60, further comprising:
subtracting the background approximation from a first frame of the movie;
identifying a first image block in the first frame; and
assigning a first trajectory to the first image block if the first image block is within a search distance of the first trajectory.

68. The method of 67, further comprising:
identifying a second image block in a second frame of the movie;
assigning the first trajectory to the second image block if the second image block is within the search distance of the first trajectory; and
determining a velocity vector for the first trajectory based on the position of the first image block in the first frame and the position of the second image block in the second frame.

69. The method of 68, further comprising:
determining a predicted position for the first trajectory based on the location of the second image block in the second frame and the velocity vector.

70. The method of 69, wherein determining a predicted position includes a prediction factor.

71. The method of 67, further comprising:
identifying a second image block in the first frame of the movie;
if the first image block and the second image block are within the search distance of the first trajectory:
determining a first distance between the first image block and the first trajectory;
determining a second distance between the second image block and the first trajectory;
assigning the first image block to the trajectory if the first distance is less than the second distance; and
assigning the second image block to the trajectory if the second distance is less than the first distance.

72. The method of 71, wherein the first distance is determined based on a current position, a predicted position, a velocity, and a predicted velocity of the first image block.

73. The method of 71, wherein the second distance is determined based on a current position, a predicted position, a velocity, and a predicted velocity of the second image block.

74. The method of 67, further comprising:
storing the first trajectory as an unassigned trajectory if no image block in the first frame is within the search distance of the first trajectory.

75. The method of 67, further comprising:
associating one or more characteristics of the first image block to the first trajectory if the first trajectory is assigned to the first image block;
identifying a second image block in the first frame;
assigning a second trajectory to the second image block if the second image block is within a search distance of the second trajectory;
associating one or more characteristics of the second image block to the second trajectory if the second trajectory is assigned to the second image block;
identifying a third image block in a second frame of the movie;
assigning the first and second trajectories to the third image block in the second frame if the third image block is within the search distances of the first and second trajectories,
wherein one or more characteristics of the first image block and the association of the first image block to the first trajectory are stored if the first and second trajectories are assigned to the third image block in the second frame, and
wherein one or more characteristics of the second image block and the association of the second image block to the second trajectory are stored if the first and second trajectories are assigned to the third image block in the second frame; and
associating one or more characteristics of the third image block to the first and second trajectories if the first and second trajectories are assigned to the third image block.

76. The method of 75, wherein the first and second trajectories are assigned to the third image block if the third image block is within a merge distance of the first and second trajectories.

77. The method of 75, further comprising:
identifying a fourth image block in a third frame of the movie; and
assigning the first trajectory or the second trajectory to the fourth image block based on a comparison of one or more characteristics of the first and second image blocks to one or more characteristics of the fourth image block.

78. The method of 77, wherein the first trajectory is assigned to the fourth image block if one or more characteristics of the fourth image block matches one or more characteristics of the first image block more than the second image block.

79. The method of 77, wherein the first trajectory is assigned to the fourth image block if one or more characteristics of the fourth image block and one or more characteristics of the first image block matches within a tolerance.

80. The method of 77, wherein the one or more characteristics include an area.

81. The method of 77, wherein the one or more characteristics include an orientation.

82. The method of 77, wherein the first or second trajectory is assigned to the fourth image block if the fourth image block is within a separation distance of the first and second trajectories.

83. The method of 68, further comprising:
determining a travel distance in a first direction and a second direction based on the velocity vector of the first trajectory.

84. The method of 68, further comprising:
determining a path length based on the velocity vector of the first trajectory.

85. The method of 68, further comprising:
determining a speed based on the velocity vector of the first trajectory.

86. The method of 68, wherein the first trajectory includes a first velocity vector and at least a second velocity vector, and further comprising:
determining an amount of turning based on an angle between the first and second velocity vectors.

87. The method of 68, wherein the second image block includes an orientation, and further comprising:
determining an amount of stumbling based on an angle between the orientation of the second image block and the velocity vector of the first trajectory.

88. A method of processing frames of a digitized movie, the method comprising:
identifying a first image block in a first frame of the movie;
assigning a first trajectory to the first image block;
identifying a second image block in the first frame;
assigning a second trajectory to the second image block;
identifying a third image block in a second frame of the movie,
wherein the first frame precedes the second frame in the movie;
assigning the first and second trajectories to the third image block if the third image block in the second frame is within a specified distance of the first and second trajectories; and
storing one or more characteristics of the first image block in association with the first trajectory and one or more characteristics of the second image block in association with the second trajectory if the third image block is assigned to the first and second trajectories.

89. The method of 88,
wherein first image block is assigned to the first trajectory when the first image block is within a search distance of the first trajectory;
wherein the second image block is assigned to the second trajectory when the second image block is within a search distance of the second trajectory; and
wherein the third image block is assigned to the first and second trajectories when the third image block is within a search distance and a merge distance of the first and second trajectories.

90. The method of 88 further comprising:
identifying a fourth image block in a third frame of the movie,
wherein the second frame precedes the third frame; and
assigning the fourth image block to the first or second trajectory based on a comparison of one or more characteristics of the fourth image block with the one or more stored characteristics associated with the first and second trajectories.

91. The method of 90, wherein the one or more characteristics include an area.

92. The method of 90, wherein the one or more characteristics include an orientation.

93. The method of 90, wherein the one or more characteristics include a velocity.

94. The method of 90, wherein the fourth image block is assigned to the first or second trajectory if the fourth image block is within a separation distance of the first and second trajectories.

95. The method of 88, further comprising:
superimposing frames of the movie to obtain a background approximation; and
determining a characteristic pixel value for pixels of the background approximation based on pixels of the superimposed frames.

96. The method of 95, wherein the characteristic pixel value is an average or a median.

97. The method of 95 further comprising:
subtracting the background approximation from the frames of the movie; and
applying a gray scale threshold to create binary images of the frames.

98. The method of 88,
wherein the first image block includes an orientation;
wherein the first trajectory includes a velocity vector;
wherein an amount of stumbling is determined based on an angle between the orientation of the first image block and the velocity vector of the first trajectory;
wherein the second image block includes an orientation;
wherein the second trajectory includes a velocity vector; and
wherein an amount of stumbling is determined based on an angle between the orientation of the second image block and the velocity vector of the second trajectory.

99. The method of 98, wherein an aggregate amount of stumbling is determined based on the amounts of stumbling determined based on the first image block, the first trajectory, the second image block, and the second trajectory.

100. The method of 98,
wherein the first image block includes a long axis and a short axis; and
wherein the orientation is determined as an angle between the long axis and a coordinate axis of the first frame.

101. A method of processing frames of a digitized movie, the method comprising:
identifying a first image block in a frame of the movie;
defining a velocity vector for the first image block;
defining an orientation for the first image block; and
determining an amount of stumbling based on an angle between the velocity vector and the orientation.

102. The method of 101, further comprising:
assigning a first trajectory to the first image block;
identifying a second image block in a second frame of the movie,
wherein the first frame precedes the second frame in the movie;
assigning the first trajectory to the second image block if the second image block is within a search distance of the first trajectory; and
determining a velocity vector for the first trajectory based on the position of the first image block in the first frame and the position of the second image block in the second frame.

103. The method of 101, further comprising:
assigning a first trajectory to the first image block;
identifying a second image block in the first frame;
assigning a second trajectory to the second image block;
identifying a third image block in a second frame of the movie,
wherein the first frame precedes the second frame in the movie;
assigning the first and second trajectories to the third image block if the third image block in the second frame is within a merge distance of the first and second trajectories; and
storing one or more characteristics of the first image block in association with the first trajectory and one or more characteristics of the second image block in association with the second trajectory if the third image block is assigned to the first and second trajectories.

104. The method of 103, further comprising:
identifying a fourth image block in a third frame of the movie,
wherein the second frame precedes the third frame; and
assigning the fourth image block to the first or second trajectory based on a comparison of one or more characteristics of the fourth image block with the one or more stored characteristics associated with the first and second trajectories.

105. The method of 104, wherein the one or more characteristics includes one or more of an area, an orientation, and velocity.

106. The method of 104, wherein the fourth image block is assigned to the first or second trajectory if the fourth image block is within a separation distance of the first and second trajectories.

107. The method of 101, further comprising:
superimposing frames of the movie to obtain a background approximation; and
determining a characteristic pixel value for pixels of the background approximation based on pixels of the superimposed frames.

108. The method of 107, wherein the characteristic pixel value is an average or a median.

109. The method of 107, further comprising:
subtracting the background approximation from the frames of the movie; and
applying a gray scale threshold to create binary images of the frames.

110. A system for processing frames of a digitized movie comprising:
a computer storage medium configured to store frames of the movie; and
a processor configured to:
superimpose frames of the movie to obtain a background approximation, and
determine a characteristic pixel value for pixels of the background approximation based on pixels of the superimposed frames.

111. The system of 1 10, wherein the processor is further configured to: subtract the background approximation from frames of the movie; and apply a gray scale threshold to create binary images of the frames.

112. The system of 110, wherein the processor is further configured to:
obtain a first frame from the computer storage medium;
subtract the background approximation from the first frame
apply a gray scale threshold to the first frame;
identify a first image block in the first frame; and
assign a first trajectory to the first image block.

113. The system of 112, wherein the processor is further configured to:
obtain a second frame of the movie from the computer storage medium;
identify a second image block in the second frame;
assign the first trajectory to the second image block if the second image block is within a search distance of the first trajectory; and
determine a velocity vector for the first trajectory based on the position of the first image block in the first frame and the position of the second image block in the second frame.

114. The system of 113, wherein the processor is further configured to:
determine a long axis and a short axis for the second image block;
determine an orientation for the second image block based on an angle between the long axis of the second image block and a coordinate axis of the second frame; and
determine an amount of stumbling based on an angle between the orientation for the second image block and the velocity vector.

115. The system of 112, wherein the processor is further configured to:
obtain a second frame of the movie from the computer storage medium;
identify a second image block in the first frame;
assign a second trajectory to the second image block;
identify a third image block in the second frame;
assign the first and second trajectories to the third image block if the third image block in the second frame is within a merge distance of the first and second trajectories; and
store in the computer storage medium one or more characteristics of the first image block in association with the first trajectory and one or more characteristics of the second image block in association with the second trajectory if the third image block is assigned to the first and second trajectories.

116. The system of 115, wherein the processor is further configured to:
obtain a third frame of the movie from the computer storage medium;
identify a fourth image block in the third frame; and
assign the fourth image block to the first or second trajectory based on a comparison of one or more characteristics of the fourth image block with the one or more stored characteristics associated with the first and second trajectories.

117. The system of 115, wherein the fourth image block is assigned to the first or second trajectory if the fourth image block is within a separation distance of the first and second trajectories.

118. A computer-readable storage medium containing computer executable instructions, the instructions when executed by a computer causing:
superimposing frames of the movie to obtain a background approximation; and
determining a characteristic pixel value for pixels of the background approximation based on pixels of the superimposed frames.

119. The computer-readable storage medium of 118, the instructions when executed further causing:
subtracting the background approximation from a first frame of the movie;
applying a gray scale threshold to the first frame;
identifying a first image block in the first frame; and
assigning a first trajectory to the first image block.

120. The computer-readable storage medium of 119, the instructions when executed further causing:
identifying a second image block in a second frame of the movie;
assigning the first trajectory to the second image block if the second image block is within a search distance of the first trajectory; and
determining a velocity vector for the first trajectory based on the position of the first image block in the first frame and the position of the second image block in the second frame.

121. The computer-readable storage medium of 120, the instructions when executed further causing:
determining a long axis and a short axis for the second image block;
determining an orientation for the second image block based on an angle between the long axis of the second image block and a coordinate axis of the second frame; and
determining an amount of stumbling based on an angle between the orientation for the second image block and the velocity vector.

122. The computer-readable storage medium of 120 the instructions when executed further causing:
identifying a second image block in the first frame;
assigning a second trajectory to the second image block;
identifying a third image block in a second frame of the movie;
assigning the first and second trajectories to the third image block if the third image block in the second frame is within a merge distance of the first and second trajectories; and
storing one or more characteristics of the first image block in association with the first trajectory and one or more characteristics of the second image block in association with the second trajectory if the third image block is assigned to the first and second trajectories.

123. The computer-readable storage medium of 122, the instructions when executed further causing:
identifying a fourth image block in a third frame of the movie; and
assigning the fourth image block to the first or second trajectory based on a comparison of one or more characteristics of the fourth image block with the one or more stored characteristics associated with the first and second trajectories.

124. The computer-readable storage medium of 123, wherein the fourth image block is assigned to the first or second trajectory if the fourth image block is within a separation distance of the first and second trajectories.
